(19) United States
(12) Patent Application Publication
(10) Pub. No.: US 2023/0419533 A1
(43) Pub. Date: Dec. 28, 2023

(54) METHODS, STORAGE MEDIA, AND SYSTEMS FOR EVALUATING CAMERA POSES

(71) Applicant: Hover Inc., San Francisco, CA (US)

(72) Inventors: Manlio Francisco Barajas Hernandez, San Francisco, CA (US); Weien Ting, Poway, CA (US)

(73) Assignee: Hover Inc., San Francisco, CA (US)

(21) Appl. No.: 18/337,666

(22) Filed: Jun. 20, 2023

Related U.S. Application Data
(60) Provisional application No. 63/509,083, filed on Jun. 20, 2023.
(60) Provisional application No. 63/509,080, filed on Jun. 20, 2023.
(60) Provisional application No. 63/355,555, filed on Jun. 24, 2022.

(51) Int. Cl. G06T 7/70; G06T 19/20; G06T 7/13; G06V 10/764

(52) U.S. Cl. CPC G06T 7/70; G06T 19/20; G06T 7/13; G06V 10/764; G06T 2219/2016; G06T 2207/30244

(57) ABSTRACT

Exemplary implementations may: receive a 3d model; identify at least first, second, and third images that observe a first 3d line segment of the 3d model; identify a 2d line segment in each of the first, second, and third images that corresponds to the first 3d line segment; triangulate the 2d line segment of the first and second images to create a second 3d line segment; triangulate the 2d line segment of the first and third images to create a third 3d line segment; triangulate the 2d line segment of the second and third images to create a fourth 3d line segment; group pose pairs, into groups, based on a parameter of the second 3d line segment, the third 3d line segment, and the fourth 3d line segment; select poses of pose pairs in a selected group of the groups comprising a largest number of pose pairs.

### CROSS REFERENCE TO RELATED APPLICATIONS

The present application claims priority to U.S. Provisional Application No. 63/509,083 filed Jun. 20, 2023, entitled “METHODS, STORAGE MEDIA, AND SYSTEMS FOR EVALUATING CAMERA POSES”, U.S. Provisional Application No. 63/509,080, entitled “METHODS, STORAGE MEDIA, AND SYSTEMS FOR GROUPING CAMERA POSES” filed on Jun. 20, 2023, and U.S. Provisional Application No. 63/355,555, entitled “METHODS, STORAGE MEDIA, AND SYSTEMS FOR EVALUATING A POSE SOLUTION FOR A PLURALITY OF RELATED IMAGES,” filed Jun. 24, 2022, which are hereby incorporated by reference in their entirety and made part of the present application for all purposes.

### BACKGROUND

### Field of the Disclosure

The present disclosure relates to methods, storage media, and systems for evaluating a pose solution for a plurality of related images.

### Description of Related Art

A plurality of images may be captured of an environment. The environment may be an exterior environment or an interior environment. The plurality of images may be used to generate a camera pose solution representing relative relationships between cameras associated with the plurality of images. The camera pose solution may be a cumulative representation of pose predictions of the cameras. The plurality of images and the camera pose solution may be used in a reconstruction pipeline, for example to generate a three-dimensional model of the environment. In some embodiments, the camera pose solution may be inaccurate, for example because one or more pose predictions may be inaccurate. Solutions for improving inaccurate camera pose solutions in a reconstruction pipeline, identifying a single inaccurate camera pose prediction among a cumulative camera pose solution, or a combination thereof, are desired.

A plurality of images and a plurality of associated camera poses may be captured of an environment. Each camera pose is a pose prediction of a camera that captured an associated image. The plurality of images and the plurality of associated camera poses may be used in a reconstruction pipeline, for example to generate a pose solution and/or to generate a three-dimensional (3d) model of the environment. In some embodiments, one or more camera poses may be inconsistent with respect to one or more other camera poses. Inconsistent poses are indicative of inherent error in the camera or image information underlying such pose, such as sensor noise or incorrect feature matching with other images. Use of inconsistent camera poses may have undesired impacts on the reconstruction pipeline, such as inaccurate pose solutions or resultant 3d models. Solutions for identifying inconsistent camera poses are desired.

### SUMMARY

In some embodiments, the problem of inaccurate camera pose solutions in a reconstruction pipeline is solved by evaluating the pose of any one camera by reprojecting a simplified geometry predicted from a cumulative camera pose solution and comparing the reprojected simplified geometry to visual geometry captured by a particular camera.

In some embodiments, the problem of identifying a single inaccurate camera pose prediction among a cumulative camera pose solution is solved by reprojecting a simplified geometry predicted from the cumulative camera pose solution and comparing the reprojected simplified geometry to visual geometry captured by a particular camera.

In some embodiments, the problem of identifying which cameras among a plurality of cameras to adjust (e.g., modify camera parameters such as location and orientation, tighten, recompute, apply more robust solve algorithms to, remove, etc.) is solved by reprojecting a simplified geometry predicted from a cumulative camera pose solution and comparing the reprojected simplified geometry to visual geometry captured by a particular camera.

One aspect of the present disclosure relates to a method for evaluating a pose solution for a plurality of related images. The method may include receiving a plurality of images. The plurality of images may include first two-dimensional line segments. The method may include generating a first pose solution for the plurality of images. The method may include generating a first line cloud based on the plurality of images. The first line cloud may include first three-dimensional line segments. The method may include generating simplified geometry based on the first line cloud. The simplified geometry may include second 3d line segments. The method may include reprojecting the second 3d line segments onto the plurality of images. The method may include, for each image of the plurality of images, calculating a per image score based on an alignment of the first 2d line segments and the reprojected second 3d line segments. The method may include validating the accuracy of the first pose solution based on the per image scores.

One aspect of the present disclosure relates to a method for evaluating a pose solution for a plurality of related images. The method may include receiving a plurality of images. The plurality of images may include first two-dimensional line segments. The method may include generating a first pose solution for the plurality of images. The method may include generating a first line cloud based on the plurality of images. The first line cloud may include first three-dimensional line segments. The method may include generating simplified geometry based on the first line cloud. The simplified geometry may include second 3d line segments. The method may include projecting the plurality of images and the second 3d line segments into a common coordinate space. The method may include, for each image of the plurality of images, calculating a per image score based on an alignment of the first 2d line segments and the second 3d line segments. The method may include validating the accuracy of the first pose solution based on the per image scores.

A plurality of images and a plurality of associated camera poses may be captured of an environment. These camera pose may be referred to as capture camera poses. Each camera pose is a pose prediction of a camera that captured an associated image. The plurality of images and the plurality of associated camera poses may be used in a reconstruction pipeline, for example to generate a pose solution and/or to generate a three-dimensional (3d) model of the environment. Generating the pose solution and/or generating the 3d model may include adjusting one or more of the camera poses. These camera pose may be referred to as modified camera poses. Adjusting a capture camera pose may include modifying position, orientation, angle, focal length, focal point, or distortion factor, such that a modified camera pose corresponds to an image associated with capture camera pose. Camera poses may be used in the reconstruction pipeline, for example to generate a pose solution, to generate a 3d model, to scale or rescale a 3d model, and the like. Modified camera poses may have different parameters (e.g., position, orientation, angle, focal point, focal length, distortion factor, etc.), than their capture camera pose counterparts, and therefore may produce a different pose solution, 3d model, scale for the 3d model, and the like. One or more capture camera poses may be inconsistent with respect to one or more other capture camera poses, for example due to accumulated drift during capture of the plurality of images and the plurality of associated capture camera poses. Solutions for grouping capture camera poses into consistent groups are desired.

One aspect of the present disclosure relates to a method for grouping different camera poses. Grouping may include batching the camera poses, or camera pose pairs, into respective bins. By grouping into bins, camera poses that produce data consistent with other camera poses may be identified. Similarly, camera poses that produce data inconsistent with other poses may be identified as outliers, and set into a separate grouping or bin as other poses. In some embodiments, “consistent” data may mean reprojection of features according to the pose of one camera is consistent with the reprojection of features according to the pose of another camera. In some embodiments, “consistent” data may be reprojection of features according to the pose of a camera pair is consistent with the reprojection of features according to the pose of another camera pair. For example, if a reprojected feature, such as a point or a line, according to the poses of two cameras is consistent with how that same feature is reprojected according to the poses of a different camera pair, then the two camera pairs may be said to be consistent. Further description of “consistent” is described below.

To identify consistency between poses, parameters of the poses may be grouped into one or more bins. When poses are associated with a particular bin, the quantity within any one bin indicates the consistency of the poses within the bin or inconsistency with poses of cameras placed in other bins. For example, if five camera pairs were prepared for grouping, and three pairs fell within one bin with the other pairs falling within other bins, the bin with the three pairs may be the most consistent camera poses of the original five pairs subject to the grouping.

Bin size may be predetermined, or responsive. Bin size may be set by a parameter of a reprojected feature; for example a first bin may be an expected value of a reprojected feature, or range encompassing the expected value. The next group of bins may be sized for a standard deviation from the expected value range given the number of camera poses, or adjustable. For example, bin sizes covering too large of a range may group all inputs within a common bin and thus preclude identifying any inconsistencies between inputs. Similarly, bin size too fine may result in only single inputs allotted to any given bin and likewise preclude determining consistency between inputs. In some embodiments, bin size and quantity for grouping is adjustable to produce a majority or plurality of inputs to a single bin among a plurality of bins.

When grouped, and consistent cameras identified, additional operations may be enabled or improved. Using consistent cameras, or discarding inconsistent cameras, may generate a new pose solution from which a new 3d model may be generated that is free of data from an inconsistent pose. Scaling information, such as from consistent cameras' positional services like an augmented reality framework, may be imputed into the 3d model (whether the original 3d model or a reconstructed 3d model).

In some embodiments, length of a reprojected feature is a parameter used to determine consistency between cameras for grouping purposes. A reprojected feature may be a linear feature, and reprojected according to its end points or other points along its length.

In some embodiments, the method may include receiving a 3d model including a plurality of 3d line segments. The method may include identifying at least first, second, and third images that observe a first 3d line segment of the plurality of 3d line segments in the model. That is, images that comprise a view of the observed first 3d line segment of the 3d model are identified. Each of the first, second, and third images may be associated with a pose. The method may include identifying a 2d line segment in each of the first, second, and third images that corresponds to the first 3d line segment. The method may include triangulating the 2d line segment of the first image and the second image to create a second 3d line segment. The method may include triangulating the 2d line segment of the first image and the third image to create a third 3d line segment. The method may include triangulating the 2d line segment of the second image and the third image to create a fourth 3d line segment. The method may include grouping pose pairs, into a plurality of groups, based on a parameter of the second 3d line segment, the third 3d line segment, and the fourth 3d line segment. The method may include selecting a group of the plurality of groups including a largest number of pose pairs. The method may include selecting poses of the pose pairs in the selected group.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for evaluating a pose solution for a plurality of related images, according to some embodiments.

FIG. 2 illustrates a method for evaluating a pose solution for a plurality of related images, according to some embodiments.

FIG. 3 illustrates a system configured for evaluating a pose solution for a plurality of related images, according to some embodiments.

FIG. 4 illustrates a method for evaluating a pose solution for a plurality of related images, according to some embodiments.

FIGS. 5A-5D illustrate line clouds according to various embodiments.

FIGS. 5E-5F illustrate point clouds according to various embodiments.

FIGS. 6A-6B illustrate simplified geometry and line clouds according to various embodiments.

FIGS. 6C-6D illustrate simplified geometry and point clouds according to various embodiments.

FIGS. 7A-7J illustrate line segments of simplified geometry reprojected onto images according to various embodiments.

FIG. 8 illustrates a system configured for grouping different camera poses, according to some embodiments.

FIG. 9 illustrates a method for grouping different camera poses, according to some embodiments.

FIG. 10 illustrates an exemplary 3d model, according to some embodiments.

FIGS. 11A, 12A, and 13A illustrate exemplary views of a 3d model, according to some embodiments.

FIGS. 11B, 12B, and 13B illustrate exemplary images, according to some embodiments.

### DETAILED DESCRIPTION

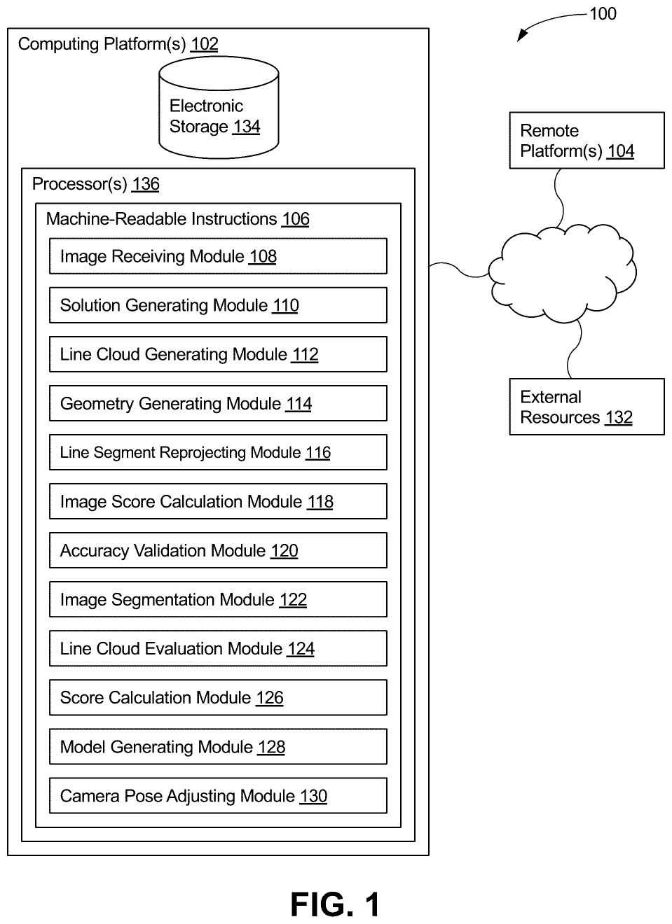

FIG. 1 illustrates a system 100 configured for evaluating a pose solution for a plurality of related images, in accordance with one or more implementations. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of image receiving module 108, solution generating module 110, line cloud generating module 112, geometry generating module 114, line segment reprojecting module 116, image score calculation module 118, accuracy validation module 120, image segmentation module 122, line cloud evaluation module 124, score calculation module 126, model generating module 128, camera pose adjusting module 130, and/or other instruction modules.

Image receiving module 108 may be configured to receive a plurality of images. Each image of the plurality of images may include at least one of visual data and depth data. By way of non-limiting example, the plurality of images may be captured by one or more of a smartphone, a tablet computer, a drone, or aerial platform. The plurality of images may include first two-dimensional line segments.

Solution generating module 110 may be configured to generate a first pose solution for the plurality of images.

Solution generating module 110 may be configured to generate a second pose solution for images of the plurality of images associated with a per image score less than a threshold number of pixels, for example 20 pixels. Per image scores are disclosed herein, for example with respect to image score calculation module 118.

Line cloud generating module 112 may be configured to generate a first line cloud based on the plurality of images. Generating the first line cloud may be based on the plurality of segmented images. Image segmentation is disclosed herein, for example with respect to image segmentation module 122. The first line cloud may include first three-dimensional line segments.

Line cloud generating module 112 may be configured to generate a second line cloud based on images of the plurality of images associated with a per image score less than a threshold number of pixels, for example 20 pixels. Per image scores are disclosed herein, for example with respect to image score calculation module 118.

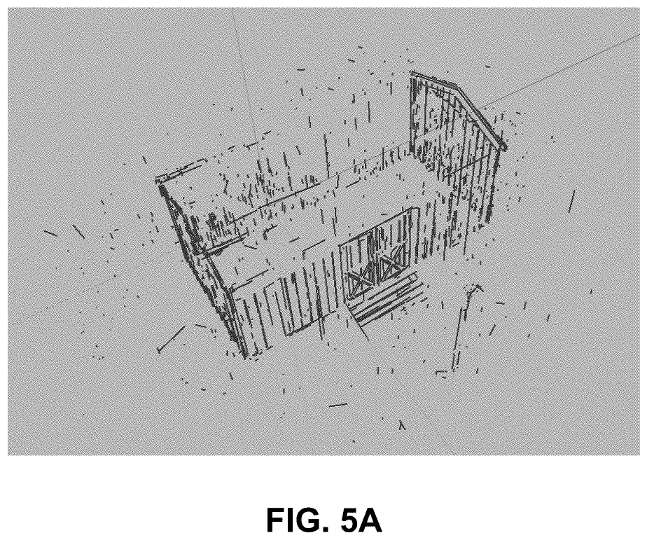

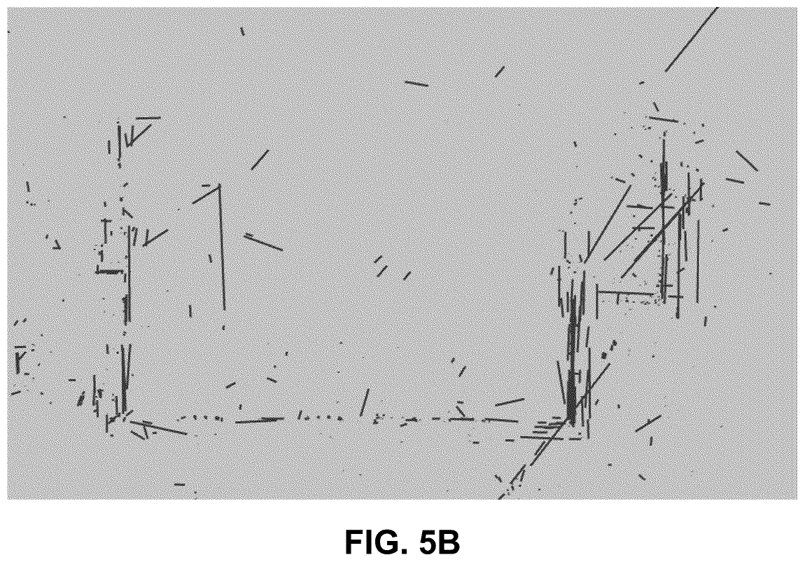

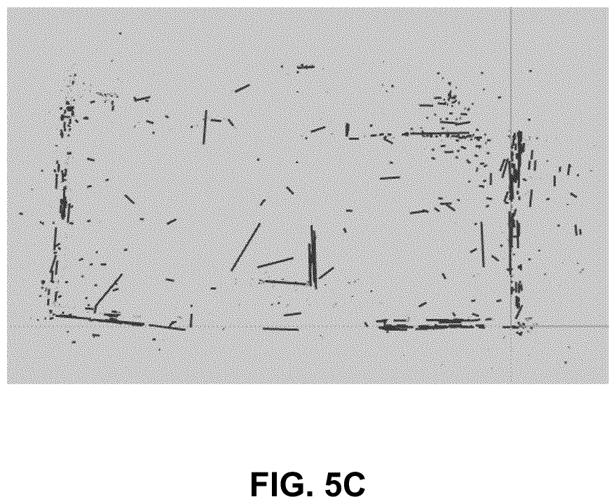

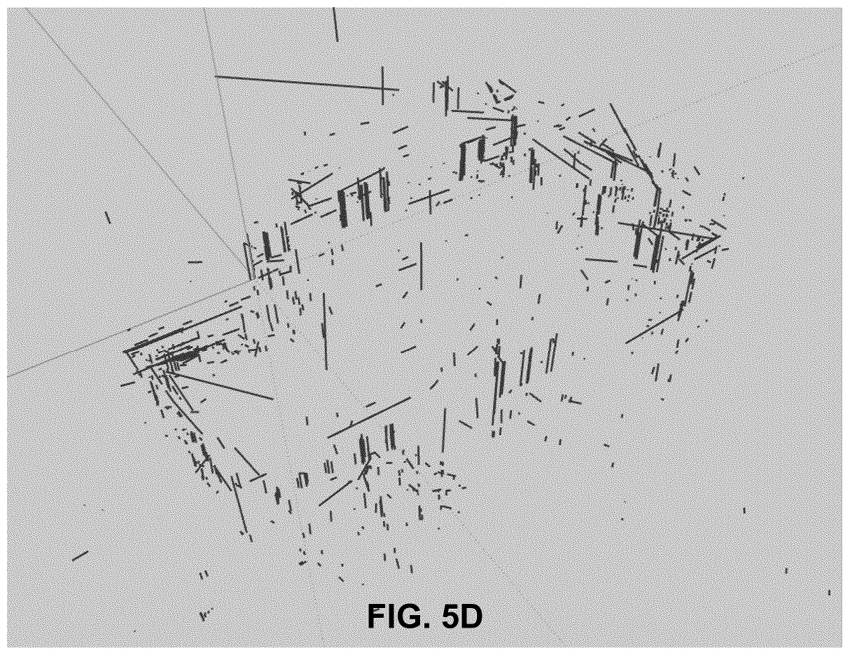

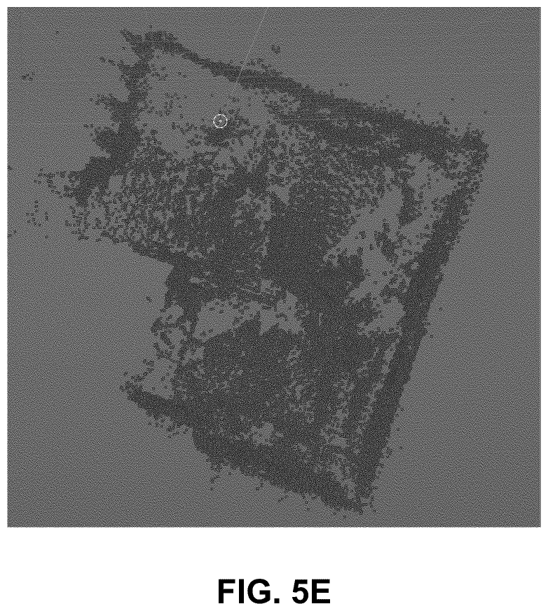

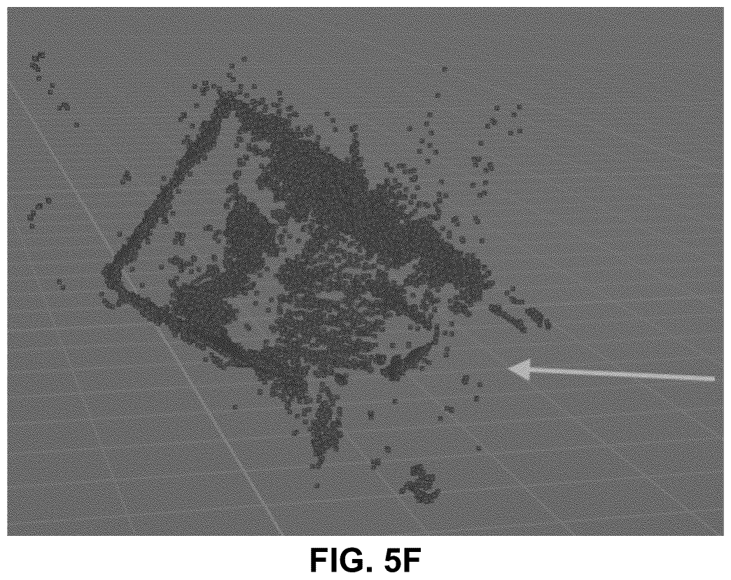

Referring briefly to FIGS. 5A-5D, they illustrate line clouds according to various embodiments.

In some embodiments, line cloud generating module 112 may be a point cloud generating module 112. In these embodiments, point cloud generating module 112 may be configured to generate a first point line cloud based on the plurality of images. Generating the first point cloud may be based on the plurality of segmented images. Image segmentation is disclosed herein, for example with respect to image segmentation module 122. In these embodiments, point cloud generating module 112 may be configured to generate a second point cloud based on images of the plurality of images associated with a per image score less than a threshold number of pixels, for example 20 pixels. Per image scores are disclosed herein, for example with respect to image score calculation module 118. Referring briefly to FIGS. 5E-5F, they illustrate point clouds according to various embodiments.

Returning to FIG. 1, geometry generating module 114 may be configured to generate simplified geometry based on the first line cloud. The simplified geometry may include one or more cuboids. Planes of the simplified geometry may be coplanar with line segments of the first line cloud. Line segments of the simplified geometry may be coplanar with line segments of the first line cloud. Points of the simplified geometry may be coplanar with line segments of the first line cloud. The simplified geometry may include second 3d line segments.

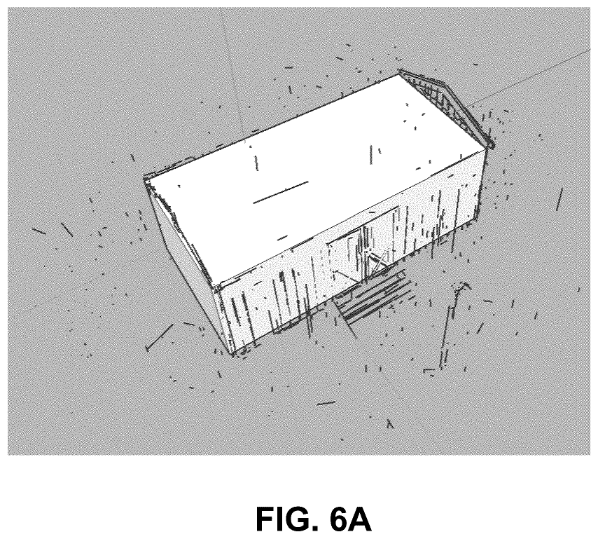

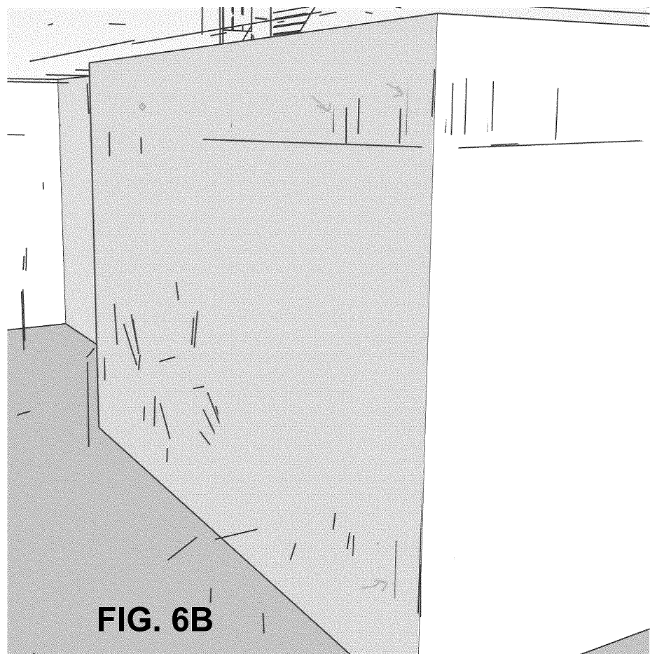

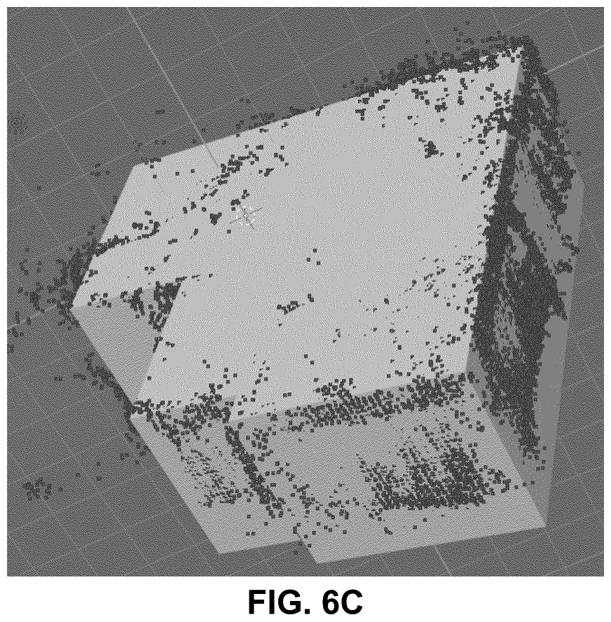

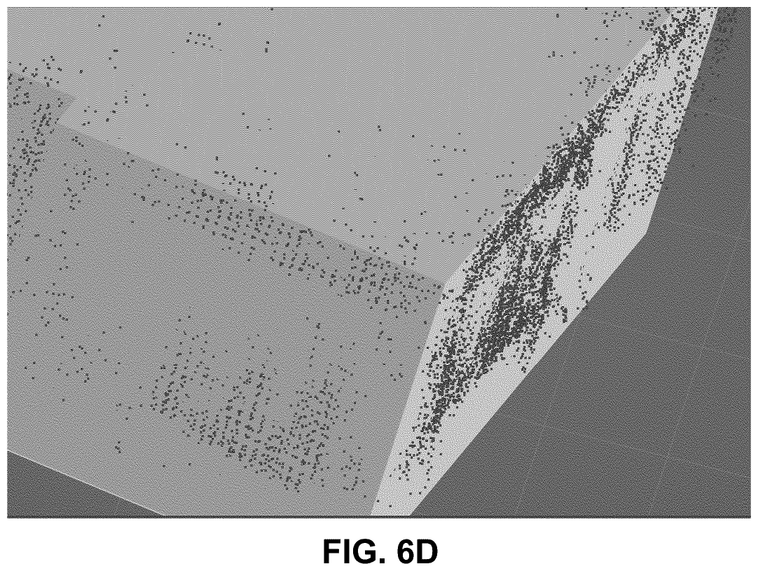

Referring briefly to FIGS. 6A-6B, they illustrate simplified geometry and a line cloud according to various embodiments. In the examples illustrated in FIGS. 6A-6B, planes, line segments, or both, of the simplified geometry are coplanar with line segments of a line cloud.

In some embodiments, geometry generating module 114 may be configured to generate simplified geometry based on the first point cloud. The simplified geometry may include one or more cuboids. The simplified geometry may include second 3d line segments. Referring briefly to FIGS. 6C-6D, they illustrate simplified geometry and a point cloud according to various embodiments.

Returning to FIG. 1, line segment reprojecting module 116 may be configured to reproject the second 3d line segments onto the plurality of images. Reprojecting the second 3d line segments onto the plurality of images may be based on real camera poses associated with the plurality of images. Reprojecting the second 3d line segments onto the plurality of images may generate second 2d line segments.

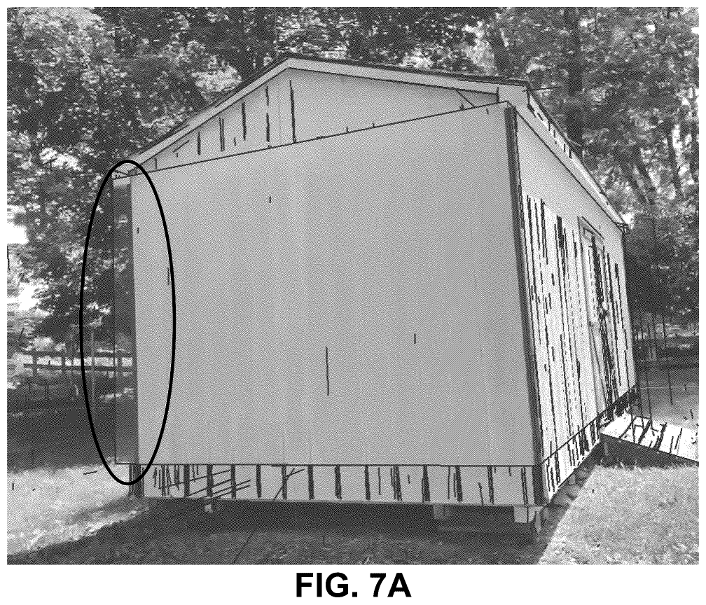

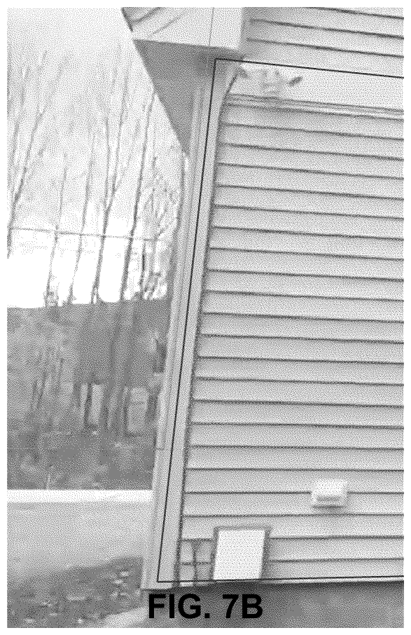

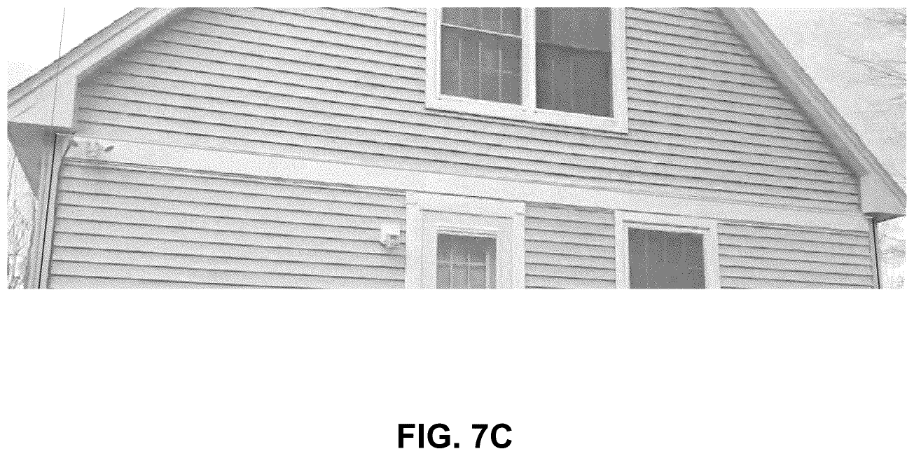

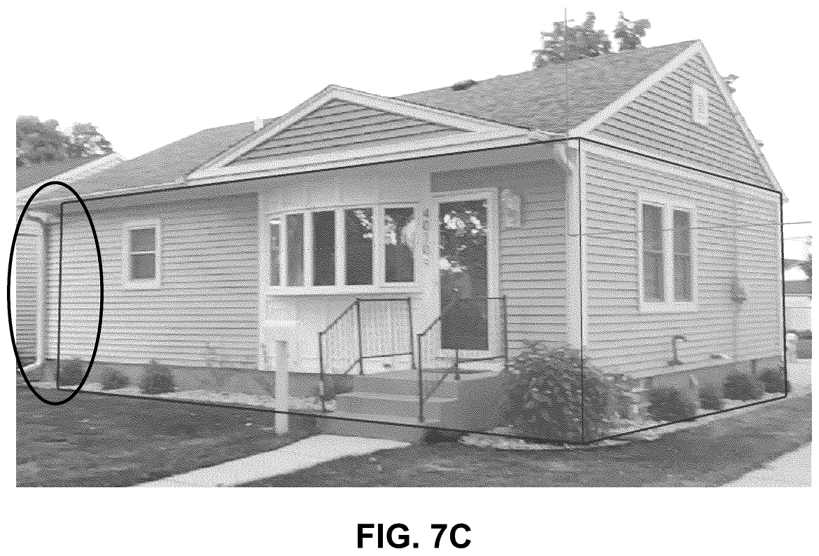

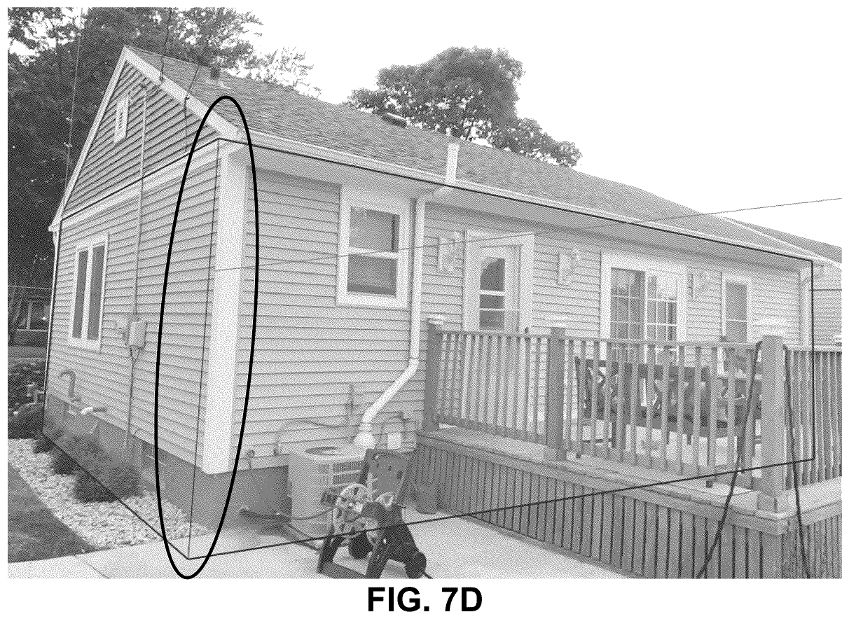

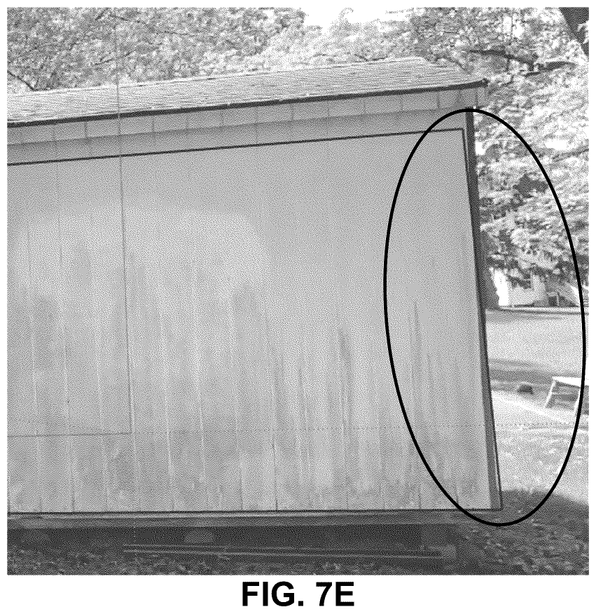

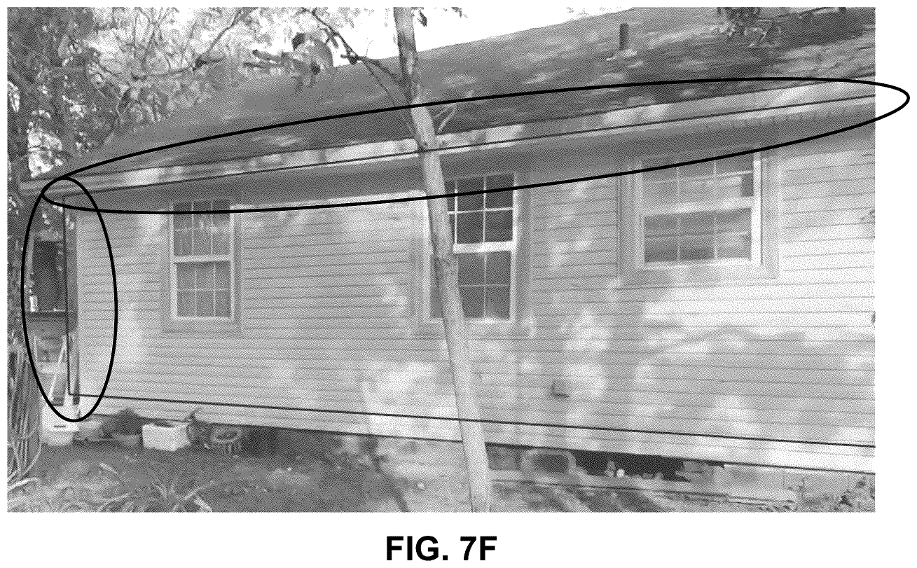

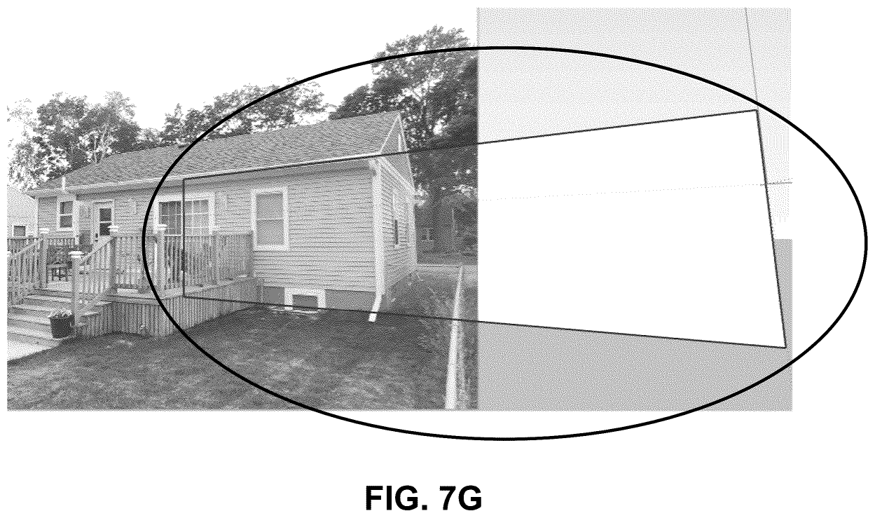

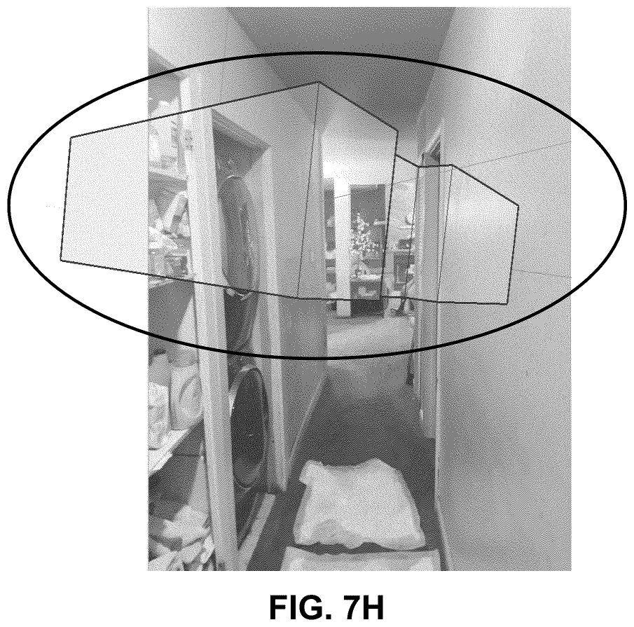

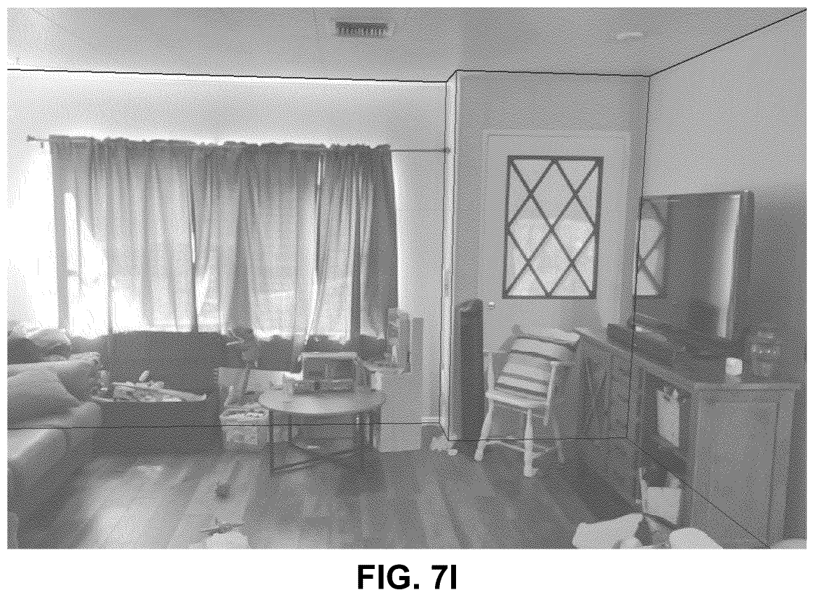

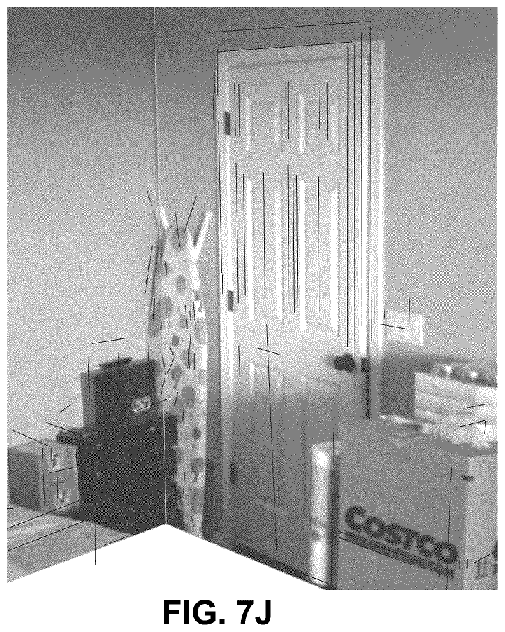

Referring briefly to FIGS. 7A-7J, they illustrate line segments of simplified geometry reprojected onto images according to various embodiments.

Returning to FIG. 1, image score calculation module 118 may be configured to, for each image of the plurality of images, calculate a per image score based on an alignment of the first 2d line segments and the reprojected second 3d line segments. Calculating the per image score may include calculating a line reprojection error between a 3d line segment of the second 3d line segments and a corresponding 2d line segment of the first 2d line segments. Calculating the per image score may include calculating a reprojection error between a vertex of the second 3d line segments and a corresponding vertex of the first 2d line segments. The per image score may be based on, related to, or a function of reprojection errors between the first 2d line segments and the projected second 3d line segments. The per image score may be in units of 2d pixels.

Referring briefly to FIGS. 7A-7J, image scores of the embodiments illustrated in FIGS. 7A, 7D, 7E, 7F, 7G, and 7H may be low as the line segments of the images do not align well with the line segments of the reprojected simplified geometries, for example at the left portion of the structure. Image scores of the embodiments illustrated in FIGS. 7B 7C, 7I, and 7J may be high as the line segments of the images align well with the line segments of the reprojected simplified geometries.

Accuracy validation module 120 may be configured to validate the accuracy of the first pose solution based on the per image scores. Validating the accuracy of the first pose solution may be further based on the aggregate score. Aggregate scores are disclosed herein, for example with reference to score calculation module 126.

Image segmentation module 122 may be configured to segment each image of the plurality of images based on a subject of interest in the plurality of images. The subject of interest may be a structure.

Line cloud evaluation module 124 may be configured to evaluate the first line cloud. In some embodiments, evaluating the first line cloud can include evaluating whether the first line cloud is a good line cloud (e.g., an acceptable line cloud) or a bad line cloud (e.g., an unacceptable line cloud). FIG. 5A illustrates a good line cloud. FIGS. 5B-5D illustrate bad line clouds. In FIG. 5A, the line cloud density is high (e.g., the line cloud includes greater than a threshold number of lines, for example at specific locations around the perimeter), the lines at corners are high (e.g., the lines at the corners are greater than a threshold number of lines), and the lines include regular angles (e.g., right angles) and remain straight (e.g., lines are straight throughout). In FIG. 5B, the line cloud density is low (e.g., the line cloud includes less than a threshold number of lines, for example at specific locations around the perimeter), and the lines at corners are low (e.g., the lines at the corners are less than a threshold number of lines). In FIG. 5C, the line cloud includes irregular angles and lines that do not remain straight (e.g., lines that are straight in some portions and angled at others). In FIG. 5D, the line cloud density is low (e.g., the line cloud includes less than a threshold number of lines).

In some embodiments, line cloud evaluation module 124 may be configured to evaluate the first point cloud. In some embodiments, evaluating the first point cloud can include evaluating whether the first point cloud is a good point cloud (e.g., an acceptable point cloud) or a bad point cloud (an unacceptable point cloud). FIG. 5E illustrates a good point cloud. FIG. 5F illustrates a bad point cloud. In FIG. 5E, the point cloud density is high throughout (e.g., the point cloud includes a greater than a threshold number of points, for example at specific locations around the perimeter for example walls and corners), and there are no holes (e.g., the point cloud includes continuous points for the floor, walls, and intersections). In FIG. 5F, the point cloud density varying (e.g., the point cloud includes a greater than a threshold number of points per unit area in some parts but not others), and there are holes (e.g., the point cloud includes no points in certain areas).

Score calculation module 126 may be configured to calculate an aggregate score based on the per image scores. Calculating the aggregate score may include calculating an average of the per image scores.

Model generating module 128 may be configured to generate 3d model based on the second line cloud.

Model generating module 128 may be configured to generate a 3d model based on images of the plurality of images associated with a per image score less than a threshold number of pixels, for example 20 pixels.

Camera pose adjusting module 130 may be configured to, for each image of the plurality of images with a per image score greater than a threshold number of pixels, for example 20 pixels, adjust a real camera pose of a real camera associated with the image. Adjusting a real camera pose of a real camera may include modifying a location, an orientation, or both of the real camera pose. In some embodiments, a real camera pose may be adjusted such that a reprojection error based on an adjusted camera pose is less than a threshold number of pixels, for example 20 pixels. In some embodiments, a real camera pose may be adjusted such that a reprojection error based on an adjusted camera pose is zero. In some embodiments, a real camera pose may be adjusted such that geometries (e.g., line segments, simplified geometry, and the like) generated based on an adjusted camera pose does not result in a reprojection error greater than a threshold for other cameras, real or adjusted.

In some implementations, computing platform(s) 102, remote platform(s) 104, and/or external resources 132 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 132 may be operatively linked via some other communication media.

A given remote platform 104 may include one or more processors configured to execute computer program modules. The computer program modules may be configured to enable an expert or user associated with the given remote platform 104 to interface with system 100 and/or external resources 132, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 132 may include sources of information outside of system 100, external entities participating with system 100, and/or other resources. In some implementations, some or all of the functionality attributed herein to external resources 132 may be provided by resources included in system 100.

Computing platform(s) 102 may include electronic storage 134, one or more processors 136, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 134 may comprise non-transitory storage media that electronically stores information. The electronic storage media of electronic storage 134 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 134 may include one or more virtual storage resources (e.g., cloud storage, a virtual private network, and/or other virtual storage resources). Electronic storage 134 may store software algorithms, information determined by processor(s) 136, information received from computing platform(s) 102, information received from remote platform(s) 104, and/or other information that enables computing platform(s) 102 to function as described herein.

Processor(s) 136 may be configured to provide information processing capabilities in computing platform(s) 102. As such, processor(s) 136 may include one or more of a digital processor, an analog processor, a digital circuit designed to process information, an analog circuit designed to process information, a state machine, and/or other mechanisms for electronically processing information. Although processor(s) 136 is shown in FIG. 1 as a single entity, this is for illustrative purposes only. In some implementations, processor(s) 136 may include a plurality of processing units. These processing units may be physically located within the same device, or processor(s) 136 may represent processing functionality of a plurality of devices operating in coordination. Processor(s) 136 may be configured to execute modules 108, 110, 112, 114, 116, 118, 120, 122, 124, 126, 128, and/or 130, and/or other modules. Processor(s) 136 may be configured to execute modules 108, 110, 112, 114, 116, 118, 120, 122, 124, 126, 128, and/or 130, and/or other modules by software; hardware; firmware; some combination of software, hardware, and/or firmware; and/or other mechanisms for configuring processing capabilities on processor(s) 136. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128, and/or 130 are illustrated in FIG. 1 as being implemented within a single processing unit, in implementations in which processor(s) 136 includes multiple processing units, one or more of modules 108, 110, 112, 114, 116, 118, 120, 122, 124, 126, 128, and/or 130 may be implemented remotely from the other modules. The description of the functionality provided by the different modules 108, 110, 112, 114, 116, 118, 120, 122, 124, 126, 128, and/or 130 described below is for illustrative purposes, and is not intended to be limiting, as any of modules 108, 110, 112, 114, 116, 118, 120, 122, 124, 126, 128, and/or 130 may provide more or less functionality than is described. For example, one or more of modules 108, 110, 112, 114, 116, 118, 120, 122, 124, 126, 128, and/or 130 may be eliminated, and some or all of its functionality may be provided by other ones of modules 108, 110, 112, 114, 116, 118, 120, 122, 124, 126, 128, and/or 130. As another example, processor(s) 136 may be configured to execute one or more additional modules that may perform some or all of the functionality attributed below to one of modules 108, 110, 112, 114, 116, 118, 120, 122, 124, 126, 128, and/or 130.

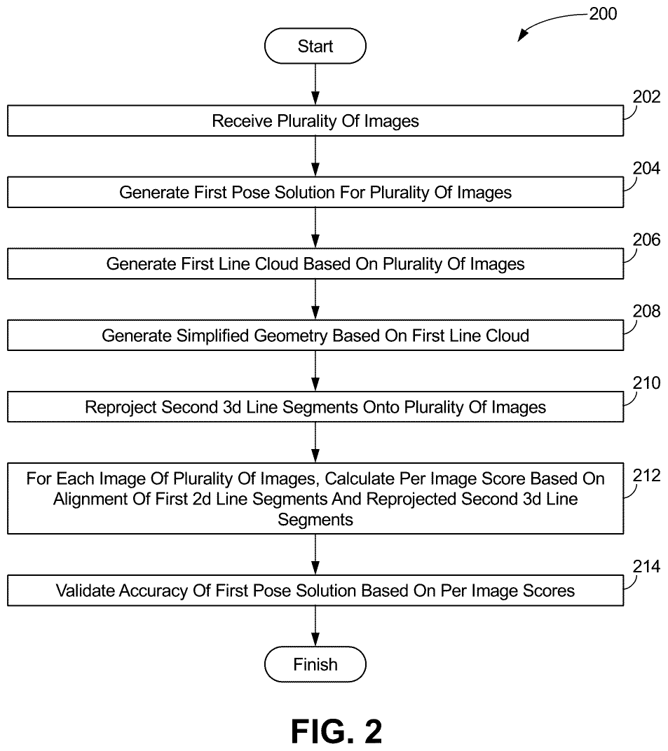

FIG. 2 illustrates a method 200 for evaluating a pose solution for a plurality of related images, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving a plurality of images. The plurality of images may include first two-dimensional line segments. In some embodiments, each image of the plurality of images includes at least one of visual data and depth data. In some embodiments, the plurality of images are captured by one or more of a smartphone, a tablet computer, a drone, or aerial platform. In some embodiments, the plurality of images are of an environment, where the environment may be an exterior environment or an interior environment. Operation 202 may be performed by one or more hardware processors configured by machine-readable instructions including a module that is the same as or similar to image receiving module 108, in accordance with one or more implementations.

An operation 204 may include generating a first pose solution for the plurality of images. Operation 204 may be performed by one or more hardware processors configured by machine-readable instructions including a module that is the same as or similar to solution generating module 110, in accordance with one or more implementations.

An operation 206 may include generating a first line cloud based on the plurality of images. The first line cloud may include first three-dimensional line segments. In some embodiments, the method 200 may include evaluating the first line cloud. Operation 206 may be performed by one or more hardware processors configured by machine-readable instructions including a module that is the same as or similar to line cloud generating module 112, in accordance with one or more implementations.

In some embodiments, method 200 may include segmenting each image of the plurality of images based on a subject of interest in the plurality of images. In these embodiments, generating the first line cloud may be based on the plurality of segmented images. In some embodiments, the subject of interest may be a structure.

Referring briefly to FIGS. 5A-5D, they illustrate line clouds according to some embodiments. FIG. 5A illustrates a good line cloud. FIGS. 5B-5D illustrate bad line clouds. In FIG. 5A, the line cloud density is high (e.g., the line cloud includes greater than a threshold number of lines, for example at specific locations around the perimeter), the lines at corners are high (e.g., the lines at the corners are greater than a threshold number of lines), and the lines include regular angles (e.g., right angles) and remain straight (e.g., lines are straight throughout). In FIG. 5B, the line cloud density is low (e.g., the line cloud includes less than a threshold number of lines, for example at specific locations around the perimeter), and the lines at corners are low (e.g., the lines at the corners are less than a threshold number of lines). In FIG. 5C, the line cloud includes irregular angles and lines that do not remain straight (e.g., lines that are straight in some portions and angled at others). In FIG. 5D, the line cloud density is low (e.g., the line cloud includes less than a threshold number of lines).

In some embodiments, operation 206 may include generating a first point cloud based on the plurality of images. Generating the first point cloud may be in place of or in addition to generating the first line cloud. In some embodiments, the method 200 may include evaluating the first point cloud.

In some embodiments, method 200 may include segmenting each image of the plurality of images based on a subject of interest in the plurality of images. In these embodiments, generating the first point cloud may be based on the plurality of segmented images. In some embodiments, the subject of interest may be a structure.

Referring briefly to FIGS. 5E-5F, they illustrate point clouds according to some embodiments. In some embodiments, evaluating the first point cloud can include evaluating whether the first point cloud is a good point cloud (e.g., an acceptable point cloud) or a bad point cloud (an unacceptable point cloud). FIG. 5E illustrates a good point cloud. FIG. 5F illustrates a bad point cloud. In FIG. 5E, the point cloud density is high throughout (e.g., the point cloud includes a greater than a threshold number of points, for example at specific locations around the perimeter for example walls and corners), and there are no holes (e.g., the point cloud includes continuous points for the floor, walls, and intersections). In FIG. 5F, the point cloud density varying (e.g., the point cloud includes a greater than a threshold number of points per unit area in some parts but not others), and there are holes (e.g., the point cloud includes no points in certain areas).

An operation 208 may include generating simplified geometry based on the first line cloud. In some embodiments, operation 208 may include generating simplified geometry based on the first point cloud. The simplified geometry may include second 3d line segments. In some embodiments, the simplified geometry includes one or more cuboids. In some embodiments, planes of the simplified geometry are coplanar with line segments of the first line cloud. In some embodiments, line segments of the simplified geometry are coplanar with line segments of the first line cloud. In some embodiments, points of the simplified geometry are coplanar with line segments of the first line cloud. Operation 208 may be performed by one or more hardware processors configured by machine-readable instructions including a module that is the same as or similar to geometry generating module 114, in accordance with one or more implementations.

Referring briefly to FIGS. 6A-6B, they illustrate simplified geometry and a line cloud according to various embodiments. In the examples illustrated in FIGS. 6A-6B, planes, line segments, or both, of the simplified geometry are coplanar with line segments of a line cloud.

Referring briefly to FIGS. 6C-6D, they illustrate simplified geometry and a point cloud according to various embodiments. In the examples illustrated in FIGS. 6C-6D, planes of the simplified geometry are coplanar with groups of points of a point cloud.

An operation 210 may include reprojecting the second 3d line segments onto the plurality of images. In some embodiments, reprojecting the second 3d line segments onto the plurality of images is based on real camera poses associated with the plurality of images. In some embodiments, reprojecting the second 3d line segments onto the plurality of images generates second 2d line segments. Operation 210 may be performed by one or more hardware processors configured by machine-readable instructions including a module that is the same as or similar to line segment reprojecting module 116, in accordance with one or more implementations.

Referring briefly to FIGS. 7A-7J, they illustrate line segments of simplified geometry reprojected onto images according to various embodiments.

An operation 212 may include for each image of the plurality of images, calculating a per image score based on an alignment of the first 2d line segments and the reprojected second 3d line segments. In some embodiments, calculating the per image score includes calculating a line reprojection error between a 3d line segment of the second 3d line segments and a corresponding 2d line segment of the first 2d line segments. In some embodiments, calculating the per image score includes calculating a reprojection error between a vertex of the second 3d line segments and a corresponding vertex of the first 2d line segments. The per image score may be based on, related to, or a function of reprojection errors between the first 2d line segments and the projected second 3d line segments. The per image score may be in units of 2d pixels. In some embodiments, the method 200 may further include generating a 3d model based on images of the plurality of images associated with a per image score less than a threshold number of pixels, for example 20 pixels. In some embodiments, the method 200 may further include generating a second pose solution for images of the plurality of images associated with a per image score less than a threshold number of pixels, for example 20 pixels. In some embodiments, the method 200 may further include generating a second line cloud based on images of the plurality of images associated with a per image score less than a threshold number of pixels, for example 20 pixels, and generating a 3d model based on the second line cloud. In some embodiments, the method 200 may further include for each image of the plurality of images with a per image score greater than a threshold number of pixels, for example 20 pixels, adjusting a real camera pose of a real camera associated with the image. Adjusting a real camera pose of a real camera may include modifying a location, an orientation, or both of the real camera pose. In some embodiments, a real camera pose may be adjusted such that a reprojection error based on an adjusted camera pose is less than a threshold number of pixels, for example 20 pixels. In some embodiments, a real camera pose may be adjusted such that a reprojection error based on an adjusted camera pose is zero. In some embodiments, a real camera pose may be adjusted such that geometries (e.g., line segments, simplified geometry, and the like) generated based on an adjusted camera pose does not result in a reprojection error greater than a threshold for other cameras, real or adjusted. Operation 212 may be performed by one or more hardware processors configured by machine-readable instructions including a module that is the same as or similar to image score calculation module 118, in accordance with one or more implementations.

Referring briefly to FIGS. 7A-7J, image scores of the embodiments illustrated in FIGS. 7A, 7D, 7E, 7F, 7G, and 7H may be low as the line segments of the images do not align well with the line segments of the reprojected simplified geometries, for example at the left portion of the structure. Image scores of the embodiments illustrated in FIGS. 7B 7C, 7I, and 7J may be high as the line segments of the images align well with the line segments of the reprojected simplified geometries.

An operation 214 may include validating the accuracy of the first pose solution based on the per image scores. In some embodiments, the method 200 may include calculating an aggregate score based on the per image scores. Calculating the aggregate score may include calculating an average of the per image scores. In these embodiments, validating the accuracy of the first pose solution may be based on the aggregate score. Operation 214 may be performed by one or more hardware processors configured by machine-readable instructions including a module that is the same as or similar to accuracy validation module 120, in accordance with one or more implementations.

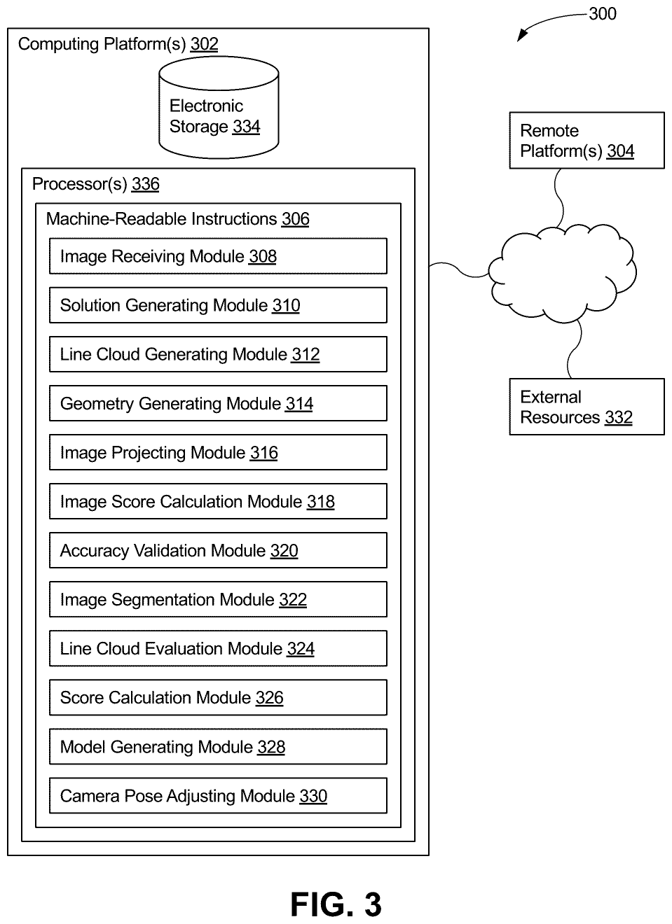

FIG. 3 illustrates a system 300 configured for evaluating a pose solution for a plurality of related images, in accordance with one or more implementations. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

Computing platform(s) 302 may be configured by machine-readable instructions 306. Machine-readable instructions 306 may include one or more instruction modules. The instruction modules may include computer program modules. The instruction modules may include one or more of image receiving module 308, solution generating module 310, line cloud generating module 312, geometry generating module 314, image projecting module 316, image score calculation module 318, accuracy validation module 320, image segmentation module 322, line cloud evaluation module 324, score calculation module 326, model generating module 328, camera pose adjusting module 330, and/or other instruction modules.

Image receiving module 308 may be configured to receive a plurality of images. Each image of the plurality of images may include at least one of visual data and depth data. By way of non-limiting example, the plurality of images may be captured by one or more of a smartphone, a tablet computer, a drone, or aerial platform. The plurality of images may include first two-dimensional line segments.

Solution generating module 310 may be configured to generate a first pose solution for the plurality of images.

Solution generating module 310 may be configured to generate a second pose solution for images of the plurality of images associated with a per image score less than a threshold number of pixels, for example 20 pixels. Per image scores are disclosed herein, for example with respect to image score calculation module 318.

Line cloud generating module 312 may be configured to generate a first line cloud based on the plurality of images. Generating the first line cloud may be based on the plurality of segmented images. Image segmentation is disclosed herein, for example with respect to image segmentation module 322. The first line cloud may include first three-dimensional line segments.

Line cloud generating module 312 may be configured to generate a second line cloud based on images of the plurality of images associated with a per image score less than a threshold number of pixels, for example 20 pixels. Per image scores are disclosed herein, for example with respect to image score calculation module 318.

Referring briefly to FIGS. 5A-5D, they illustrate line clouds according to various embodiments.

In some embodiments, line cloud generating module 312 may be a point cloud generating module 312. In these embodiments, point cloud generating module 312 may be configured to generate a first point line cloud based on the plurality of images. Generating the first point cloud may be based on the plurality of segmented images. Image segmentation is disclosed herein, for example with respect to image segmentation module 322. In these embodiments, point cloud generating module 312 may be configured to generate a second point cloud based on images of the plurality of images associated with a per image score less than a threshold number of pixels, for example 20 pixels. Per image scores are disclosed herein, for example with respect to image score calculation module 318. Referring briefly to FIGS. 5E-5F, they illustrate point clouds according to various embodiments.

Returning to FIG. 3, geometry generating module 314 may be configured to generate simplified geometry based on the first line cloud. The simplified geometry may include one or more cuboids. Planes of the simplified geometry may be coplanar with line segments of the first line cloud. Line segments of the simplified geometry may be coplanar with line segments of the first line cloud. Points of the simplified geometry may be coplanar with line segments of the first line cloud. The simplified geometry may include second 3d line segments.

Referring briefly to FIGS. 6A-6B, they illustrate simplified geometry and a line cloud according to various embodiments. In the examples illustrated in FIGS. 6A-6B, planes, line segments, or both, of the simplified geometry are coplanar with line segments of a line cloud.

In some embodiments, geometry generating module 314 may be configured to generate simplified geometry based on the first point cloud. The simplified geometry may include one or more cuboids. The simplified geometry may include second 3d line segments. Referring briefly to FIGS. 6C-6D, they illustrate simplified geometry and a point cloud according to various embodiments.

Returning to FIG. 3, image projecting module 316 may be configured to project the plurality of images and the second 3d line segments into a common coordinate space. Projecting the plurality of images and the second 3d line segments into the common coordinate space may be based on real camera poses associated with the plurality of images.

Image score calculation module 318 may be configured to, for each image of the plurality of images, calculate a per image score based on an alignment of the first 2d line segments and the second 3d line segments. Calculating the per image score may include calculating an error between a 3d line segment of the second 3d line segments and a corresponding 2d line segment of the first 2d line segments. Calculating the per image score may include calculating an error between a vertex of the second 3d line segments and a corresponding vertex of the first 2d line segments. The per image score may be based on, related to, or a function of reprojection errors between the first 2d line segments and the projected second 3d line segments. The per image score may be in units of 2d pixels.

Accuracy validation module 320 may be configured to validate the accuracy of the first pose solution based on the per image scores. Validating the accuracy of the first pose solution may be further based on the aggregate score. Aggregate scores are disclosed herein, for example with reference to score calculation module 326.

Image segmentation module 322 may be configured to segment each image of the plurality of images based on a subject of interest in the plurality of images. The subject of interest may be a structure.

Line cloud evaluation module 324 may be configured to evaluate the first line cloud. In some embodiments, evaluating the first line cloud can include evaluating whether the first line cloud is a good line cloud (e.g., an acceptable line cloud) or a bad line cloud (e.g., an unacceptable line cloud). FIG. 5A illustrates a good line cloud. FIGS. 5B-5D illustrate bad line clouds. In FIG. 5A, the line cloud density is high (e.g., the line cloud includes greater than a threshold number of lines, for example at specific locations around the perimeter), the lines at corners are high (e.g., the lines at the corners are greater than a threshold number of lines), and the lines include regular angles (e.g., right angles) and remain straight (e.g., lines are straight throughout). In FIG. 5B, the line cloud density is low (e.g., the line cloud includes less than a threshold number of lines, for example at specific locations around the perimeter), and the lines at corners are low (e.g., the lines at the corners are less than a threshold number of lines). In FIG. 5C, the line cloud includes irregular angles and lines that do not remain straight (e.g., lines that are straight in some portions and angled at others). In FIG. 5D, the line cloud density is low (e.g., the line cloud includes less than a threshold number of lines).

In some embodiments, line cloud evaluation module 324 may be configured to evaluate the first point cloud. In some embodiments, evaluating the first point cloud can include evaluating whether the first point cloud is a good point cloud (e.g., an acceptable point cloud) or a bad point cloud (an unacceptable point cloud). FIG. 5E illustrates a good point cloud. FIG. 5F illustrates a bad point cloud. In FIG. 5E, the point cloud density is high throughout (e.g., the point cloud includes a greater than a threshold number of points, for example at specific locations around the perimeter for example walls and corners), and there are no holes (e.g., the point cloud includes continuous points for the floor, walls, and intersections). In FIG. 5F, the point cloud density varying (e.g., the point cloud includes a greater than a threshold number of points per unit area in some parts but not others), and there are holes (e.g., the point cloud includes no points in certain areas).

Score calculation module 326 may be configured to calculate an aggregate score based on the per image scores. Calculating the aggregate score may include calculating an average of the per image scores.

Model generating module 328 may be configured to generate 3d model based on the second line cloud.

Model generating module 328 may be configured to generate a 3d model based on images of the plurality of images associated with a per image score less than a threshold number of pixels, for example 20 pixels.

Camera pose adjusting module 330 may be configured to, for each image of the plurality of images with a per image score greater than a threshold number of pixels, for example 20 pixels, adjust a real camera pose of a real camera associated with the image. Adjusting a real camera pose of a real camera may include modifying a location, an orientation, or both of the real camera pose. In some embodiments, a real camera pose may be adjusted such that a reprojection error based on an adjusted camera pose is less than a threshold number of pixels, for example 20 pixels. In some embodiments, a real camera pose may be adjusted such that a reprojection error based on an adjusted camera pose is zero. In some embodiments, a real camera pose may be adjusted such that geometries (e.g., line segments, simplified geometry, and the like) generated based on an adjusted camera pose does not result in a reprojection error greater than a threshold for other cameras, real or adjusted.

In some implementations, computing platform(s) 302, remote platform(s) 304, and/or external resources 332 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 332 may be operatively linked via some other communication media.

A given remote platform 304 may include one or more processors configured to execute computer program modules. The computer program modules may be configured to enable an expert or user associated with the given remote platform 304 to interface with system 300 and/or external resources 332, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 332 may include sources of information outside of system 300, external entities participating with system 300, and/or other resources. In some implementations, some or all of the functionality attributed herein to external resources 332 may be provided by resources included in system 300.

Computing platform(s) 302 may include electronic storage 334, one or more processors 336, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 334 may comprise non-transitory storage media that electronically stores information. The electronic storage media of electronic storage 334 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 334 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 334 may include one or more virtual storage resources (e.g., cloud storage, a virtual private network, and/or other virtual storage resources). Electronic storage 334 may store software algorithms, information determined by processor(s) 336, information received from computing platform(s) 302, information received from remote platform(s) 304, and/or other information that enables computing platform(s) 302 to function as described herein.

Processor(s) 336 may be configured to provide information processing capabilities in computing platform(s) 302. As such, processor(s) 336 may include one or more of a digital processor, an analog processor, a digital circuit designed to process information, an analog circuit designed to process information, a state machine, and/or other mechanisms for electronically processing information. Although processor(s) 336 is shown in FIG. 3 as a single entity, this is for illustrative purposes only. In some implementations, processor(s) 336 may include a plurality of processing units. These processing units may be physically located within the same device, or processor(s) 336 may represent processing functionality of a plurality of devices operating in coordination. Processor(s) 336 may be configured to execute modules 308, 310, 312, 314, 316, 318, 320, 322, 324, 326, 328, and/or 330, and/or other modules. Processor(s) 336 may be configured to execute modules 308, 310, 312, 314, 316, 318, 320, 322, 324, 326, 328, and/or 330, and/or other modules by software; hardware; firmware; some combination of software, hardware, and/or firmware; and/or other mechanisms for configuring processing capabilities on processor(s) 336. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, 316, 318, 320, 322, 324, 326, 328, and/or 330 are illustrated in FIG. 3 as being implemented within a single processing unit, in implementations in which processor(s) 336 includes multiple processing units, one or more of modules 308, 310, 312, 314, 316, 318, 320, 322, 324, 326, 328, and/or 330 may be implemented remotely from the other modules. The description of the functionality provided by the different modules 308, 310, 312, 314, 316, 318, 320, 322, 324, 326, 328, and/or 330 described below is for illustrative purposes, and is not intended to be limiting, as any of modules 308, 310, 312, 314, 316, 318, 320, 322, 324, 326, 328, and/or 330 may provide more or less functionality than is described. For example, one or more of modules 308, 310, 312, 314, 316, 318, 320, 322, 324, 326, 328, and/or 330 may be eliminated, and some or all of its functionality may be provided by other ones of modules 308, 310, 312, 314, 316, 318, 320, 322, 324, 326, 328, and/or 330. As another example, processor(s) 336 may be configured to execute one or more additional modules that may perform some or all of the functionality attributed below to one of modules 308, 310, 312, 314, 316, 318, 320, 322, 324, 326, 328, and/or 330.

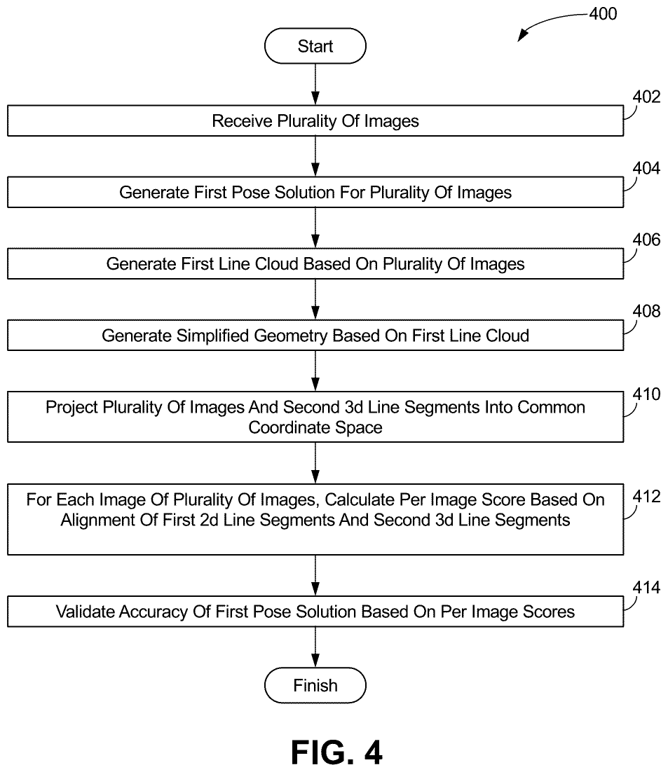

FIG. 4 illustrates a method 400 for evaluating a pose solution for a plurality of related images, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 402 may include receiving a plurality of images. The plurality of images may include first two-dimensional line segments. Each image of the plurality of images may include at least one of visual data and depth data. In some embodiments, the plurality of images are captured by one or more of a smartphone, a tablet computer, a drone, or aerial platform. In some embodiments, the plurality of images are of an environment, where the environment may be an exterior environment or an interior environment. Operation 402 may be performed by one or more hardware processors configured by machine-readable instructions including a module that is the same as or similar to image receiving module 308, in accordance with one or more implementations.

An operation 404 may include generating a first pose solution for the plurality of images. Operation 404 may be performed by one or more hardware processors configured by machine-readable instructions including a module that is the same as or similar to solution generating module 310, in accordance with one or more implementations.

An operation 406 may include generating a first line cloud based on the plurality of images. The first line cloud may include first three-dimensional line segments. In some embodiments, the method 400 may further include evaluating the first line cloud. Operation 406 may be performed by one or more hardware processors configured by machine-readable instructions including a module that is the same as or similar to line cloud generating module 312, in accordance with one or more implementations.

In some embodiments, the method 400 may further include segmenting each image of the plurality of images based on a subject of interest in the plurality of images. In these embodiments, generating the first line cloud may be based on the plurality of segmented images. In some embodiments, the subject of interest is a structure.

Referring briefly to FIGS. 5A-5D, they illustrate line clouds according to some embodiments. FIG. 5A illustrates a good line cloud. FIGS. 5B-5D illustrate bad line clouds. In FIG. 5A, the line cloud density is high (e.g., the line cloud includes greater than a threshold number of lines, for example at specific locations around the perimeter), the lines at corners are high (e.g., the lines at the corners are greater than a threshold number of lines), and the lines include regular angles (e.g., right angles) and remain straight (e.g., lines are straight throughout). In FIG. 5B, the line cloud density is low (e.g., the line cloud includes less than a threshold number of lines, for example at specific locations around the perimeter), and the lines at corners are low (e.g., the lines at the corners are less than a threshold number of lines). In FIG. 5C, the line cloud includes irregular angles and lines that do not remain straight (e.g., lines that are straight in some portions and angled at others). In FIG. 5D, the line cloud density is low (e.g., the line cloud includes less than a threshold number of lines).

In some embodiments, operation 406 may include generating a first point cloud based on the plurality of images. Generating the first point cloud may be in place of or in addition to generating the first line cloud. In some embodiments, the method 200 may include evaluating the first point cloud.

In some embodiments, method 400 may include segmenting each image of the plurality of images based on a subject of interest in the plurality of images. In these embodiments, generating the first point cloud may be based on the plurality of segmented images. In some embodiments, the subject of interest may be a structure.

Referring briefly to FIGS. 5E-5F, they illustrate point clouds according to some embodiments. In some embodiments, evaluating the first point cloud can include evaluating whether the first point cloud is a good point cloud (e.g., an acceptable point cloud) or a bad point cloud (an unacceptable point cloud). FIG. 5E illustrates a good point cloud. FIG. 5F illustrates a bad point cloud. In FIG. 5E, the point cloud density is high throughout (e.g., the point cloud includes a greater than a threshold number of points, for example at specific locations around the perimeter for example walls and corners), and there are no holes (e.g., the point cloud includes continuous points for the floor, walls, and intersections). In FIG. 5F, the point cloud density varying (e.g., the point cloud includes a greater than a threshold number of points per unit area in some parts but not others), and there are holes (e.g., the point cloud includes no points in certain areas).

An operation 408 may include generating simplified geometry based on the first line cloud. In some embodiments, operation 408 may include generating simplified geometry based on the first point cloud. The simplified geometry may include second 3d line segments. In some embodiments, the simplified geometry comprises one or more cuboids. In some embodiments, planes of the simplified geometry are coplanar with line segments of the first line cloud. In some embodiments, line segments of the simplified geometry are coplanar with line segments of the first line cloud. In some embodiments, points of the simplified geometry are coplanar with line segments of the first line cloud. Operation 408 may be performed by one or more hardware processors configured by machine-readable instructions including a module that is the same as or similar to geometry generating module 314, in accordance with one or more implementations.

Referring briefly to FIGS. 6A-6B, they illustrate simplified geometry and a line cloud according to various embodiments. In the examples illustrated in FIGS. 6A-6B, planes, line segments, or both, of the simplified geometry are coplanar with line segments of a line cloud.

Referring briefly to FIGS. 6C-6D, they illustrate simplified geometry and a point cloud according to various embodiments. In the examples illustrated in FIGS. 6C-6D, planes of the simplified geometry are coplanar with groups of points of a point cloud.

An operation 410 may include projecting the plurality of images and the second 3d line segments into a common coordinate space. In some embodiments, projecting the plurality of images and the second 3d line segments into the common coordinate space is based on real camera poses associated with the plurality of images. Operation 410 may be performed by one or more hardware processors configured by machine-readable instructions including a module that is the same as or similar to image projecting module 316, in accordance with one or more implementations.

An operation 412 may include for each image of the plurality of images, calculating a per image score based on an alignment of the first 2d line segments and the second 3d line segments. In some embodiments, calculating the per image score comprises calculating an error between a 3d line segment of the second 3d line segments and a corresponding 2d line segment of the first 2d line segments. In some embodiments, calculating the per image score comprises calculating an error between a vertex of the second 3d line segments and a corresponding vertex of the first 2d line segments. The per image score may be based on, related to, or a function of reprojection errors between the first 2d line segments and the projected second 3d line segments. The per image score may be in units of 2d pixels. In some embodiments, the method 400 may further include generating a second pose solution for images of the plurality of images associated with a per image score less than a threshold number of pixels, for example 20 pixels. In some embodiments, the method 400 may further include generating a second line cloud based on images of the plurality of images associated with a per image score less than a threshold number of pixels, for example 20 pixels, and generating a 3d model based on the second line cloud. In some embodiments, the method 400 may include generating a 3d model based on images of the plurality of images associated with a per image score less than a threshold number of pixels, for example 20 pixels. The method 400 may further include for each image of the plurality of images with a per image score greater than a threshold number of pixels, for example 20 pixels, adjusting a real camera pose of a real camera associated with the image. Adjusting a real camera pose of a real camera may include modifying a location, an orientation, or both of the real camera pose. In some embodiments, a real camera pose may be adjusted such that a reprojection error based on an adjusted camera pose is less than a threshold number of pixels, for example 20 pixels. In some embodiments, a real camera pose may be adjusted such that a reprojection error based on an adjusted camera pose is zero. In some embodiments, a real camera pose may be adjusted such that geometries (e.g., line segments, simplified geometry, and the like) generated based on an adjusted camera pose does not result in a reprojection error greater than a threshold for other cameras, real or adjusted. Operation 412 may be performed by one or more hardware processors configured by machine-readable instructions including a module that is the same as or similar to image score calculation module 318, in accordance with one or more implementations.

An operation 414 may include validating the accuracy of the first pose solution based on the per image scores. In some embodiments, method 400 further includes calculating an aggregate score based on the per image scores. In some embodiments, calculating the aggregate sore includes calculating an average of the per image scores. In these embodiments, validating the first pose solution is further based on the aggregate score. Operation 414 may be performed by one or more hardware processors configured by machine-readable instructions including a module that is the same as or similar to accuracy validation module 320, in accordance with one or more implementations.

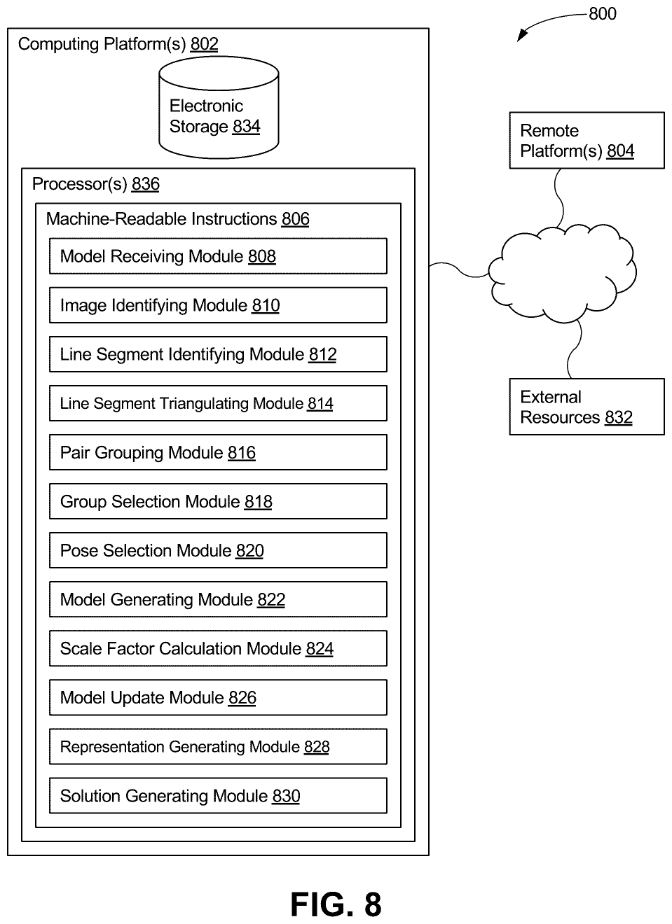

FIG. 8 illustrates a system 800 configured for grouping different camera poses, in accordance with one or more implementations. In some implementations, system 800 may include one or more computing platforms 802. Computing platform(s) 802 may be configured to communicate with one or more remote platforms 804 according to a client/server architecture, a peer-to-peer architecture, and/or other architectures. Remote platform(s) 804 may be configured to communicate with other remote platforms via computing platform(s) 802 and/or according to a client/server architecture, a peer-to-peer architecture, and/or other architectures. Users may access system 800 via remote platform(s) 804.

Computing platform(s) 802 may be configured by machine-readable instructions 806. Machine-readable instructions 806 may include one or more instruction modules. The instruction modules may include computer program modules. The instruction modules may include one or more of model receiving module 808, image identifying module 810, line segment identifying module 812, line segment triangulating module 814, pair grouping module 816, group selection module 818, pose selection module 820, model generating module 822, factor calculation module 824, model update module 826, representation generating module 828, solution generating module 830, and/or other instruction modules.

Model receiving module 808 may be configured to receive a 3d model including a plurality of 3d line segments. The 3d model may be a polygon-based model, a primitive-base model, a line cloud, or a mesh model. Generating the 3d model may include adjusting at least one of the first pose, the second pose, or the third pose. Adjusting at least one of the first pose, the second pose, or the third pose may include adjusting at least one of the first pose, the second pose, or the third pose in a 3d coordinate system. Adjusting at least one of the first pose, the second pose, or the third pose may include modifying at least one of position, orientation, angle, focal length, focal point, or distortion factor. The 3d model may be not generated based on the first, second, and third images.

Image identifying module 810 may be configured to identify at least first, second, and third images that observe a first 3d line segment of the plurality of 3d line segments in the model. That is, images that comprise a view of the observed first 3d line segment of the model are identified. Each of the first, second, and third images may be associated with a pose.

Line segment identifying module 812 may be configured to identify a 2d line segment in each of the first, second, and third images that corresponds to the first 3d line segment. The first 3d line segment and the 2d line segment of the first, second, and third images may be vertical line segments. The first 3d line segment and the 2d line segment of the first, second, and third images may be orthogonal to a ground plane. The first 3d line segment and the 2d line segment of the first, second, and third images may be horizontal line segments. The first 3d line segment and the 2d line segment of the first, second, and third images may be parallel to a ground plane.

Line segment triangulating module 814 may be configured to triangulate the 2d line segment of the first image and the second image to create a second 3d line segment. Line segment triangulating module 814 may be configured to triangulate the 2d line segment of the first image and the third image to create a third 3d line segment. Line segment triangulating module 814 may be configured to triangulate the 2d line segment of the second image and the third image to create a fourth 3d line segment.

Pair grouping module 816 may be configured to group pose pairs, into a plurality of groups, based on a parameter of the second 3d line segment, the third 3d line segment, and the fourth 3d line segment. The parameter may be length. The parameter may be 3d coordinates of points. The points may be of 3d line segments. For example, line segments that reproject as vertical may be distinguished from line segments that are non-vertical. The points may be end points of 3d line segments. The parameter may be orientation. The parameter may be location.

A bin size of each group of the plurality of groups may be based on one or more expected values of the first 3d line segment. The one or more expected values may be based on the first 3d line segment. The one or more expected values may be based on a semantic class associated with the first 3d line segment. Each expected value of the one or more expected values may be based on an industry standard value. The bin size may be a percentage of the one or more expected values. The percentage may correspond to an error threshold. The percentage may be three percent. The error threshold may be based on sensor quality.

Group selection module 818 may be configured to select a group of the plurality of groups including a largest number of pose pairs.

Pose selection module 820 may be configured to select poses of the pose pairs in the selected group.

Model generating module 822 may be configured to generate the 3d model based on at least the first, second, and third images.

Scale factor calculation module 824 may be configured to calculate a scaling factor based on the selected poses. Calculating the scaling factor may include calculating a mean of lengths of 3d line segments associated with the selected group. Calculating the scaling factor may include calculating a median of lengths of 3d line segments associated with the selected group. Calculating the scaling factor may include calculating a midpoint of a bin range of the selected group. Calculating the scaling factor may include leveraging scene data as produced by augmented reality frameworks of the cameras in the selected group or associated with the selected poses.

Model update module 826 may be configured to update the 3d model based on the scaling factor. Updating may include scaling the 3d model based on the scaling factor. Scaling the 3d model may include uniformly scaling the 3d model based on the scaling factor. Scaling the 3d model may include non-uniformly scaling the 3d model based on the scaling factor. Model update module 826 may be configured to update the 3d model based on the selected poses.

Representation generating module 828 may be configured to generate a new 3d representation based on the selected poses. The new 3d representation may be a mesh. The new 3d representation may be a second 3d model.

Solution generating module 830 may be configured to generate a new pose solution based on the selected poses. Generating the new pose solution may be further based on images associated with the selected poses.

In some implementations, computing platform(s) 802, remote platform(s) 804, and/or external resources 832 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 802, remote platform(s) 804, and/or external resources 832 may be operatively linked via some other communication media.

A given remote platform 804 may include one or more processors configured to execute computer program modules. The computer program modules may be configured to enable an expert or user associated with the given remote platform 804 to interface with system 800 and/or external resources 832, and/or provide other functionality attributed herein to remote platform(s) 804. By way of non-limiting example, a given remote platform 804 and/or a given computing platform 802 may include one or more of a server, a desktop computer, a laptop computer, a handheld computer, a tablet computing platform, a NetBook, a Smartphone, a gaming console, and/or other computing platforms.

External resources 832 may include sources of information outside of system 800, external entities participating with system 800, and/or other resources. In some implementations, some or all of the functionality attributed herein to external resources 832 may be provided by resources included in system 800.

Computing platform(s) 802 may include electronic storage 834, one or more processors 836, and/or other components. Computing platform(s) 802 may include communication lines, or ports to enable the exchange of information with a network and/or other computing platforms. Illustration of computing platform(s) 802 in FIG. 8 is not intended to be limiting. Computing platform(s) 802 may include a plurality of hardware, software, and/or firmware components operating together to provide the functionality attributed herein to computing platform(s) 802. For example, computing platform(s) 802 may be implemented by a cloud of computing platforms operating together as computing platform(s) 802.

Electronic storage 834 may comprise non-transitory storage media that electronically stores information. The electronic storage media of electronic storage 834 may include one or both of system storage that is provided integrally (i.e., substantially non-removable) with computing platform(s) 802 and/or removable storage that is removably connectable to computing platform(s) 802 via, for example, a port (e.g., a USB port, a firewire port, etc.) or a drive (e.g., a disk drive, etc.). Electronic storage 834 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 834 may include one or more virtual storage resources (e.g., cloud storage, a virtual private network, and/or other virtual storage resources). Electronic storage 834 may store software algorithms, information determined by processor(s) 836, information received from computing platform(s) 802, information received from remote platform(s) 804, and/or other information that enables computing platform(s) 802 to function as described herein.

Processor(s) 836 may be configured to provide information processing capabilities in computing platform(s) 802. As such, processor(s) 836 may include one or more of a digital processor, an analog processor, a digital circuit designed to process information, an analog circuit designed to process information, a state machine, and/or other mechanisms for electronically processing information. Although processor(s) 836 is shown in FIG. 8 as a single entity, this is for illustrative purposes only. In some implementations, processor(s) 836 may include a plurality of processing units. These processing units may be physically located within the same device, or processor(s) 836 may represent processing functionality of a plurality of devices operating in coordination. Processor(s) 836 may be configured to execute modules 808, 810, 812, 814, 816, 818, 820, 822, 824, 826, 828, and/or 830, and/or other modules. Processor(s) 836 may be configured to execute modules 808, 810, 812, 814, 816, 818, 820, 822, 824, 826, 828, and/or 830, and/or other modules by software; hardware; firmware; some combination of software, hardware, and/or firmware; and/or other mechanisms for configuring processing capabilities on processor(s) 836. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 808, 810, 812, 814, 816, 818, 820, 822, 824, 826, 828, and/or 830 are illustrated in FIG. 8 as being implemented within a single processing unit, in implementations in which processor(s) 836 includes multiple processing units, one or more of modules 808, 810, 812, 814, 816, 818, 820, 822, 824, 826, 828, and/or 830 may be implemented remotely from the other modules. The description of the functionality provided by the different modules 808, 810, 812, 814, 816, 818, 820, 822, 824, 826, 828, and/or 830 described below is for illustrative purposes, and is not intended to be limiting, as any of modules 808, 810, 812, 814, 816, 818, 820, 822, 824, 826, 828, and/or 830 may provide more or less functionality than is described. For example, one or more of modules 808, 810, 812, 814, 816, 818, 820, 822, 824, 826, 828, and/or 830 may be eliminated, and some or all of its functionality may be provided by other ones of modules 808, 810, 812, 814, 816, 818, 820, 822, 824, 826, 828, and/or 830. As another example, processor(s) 836 may be configured to execute one or more additional modules that may perform some or all of the functionality attributed below to one of modules 808, 810, 812, 814, 816, 818, 820, 822, 824, 826, 828, and/or 830.

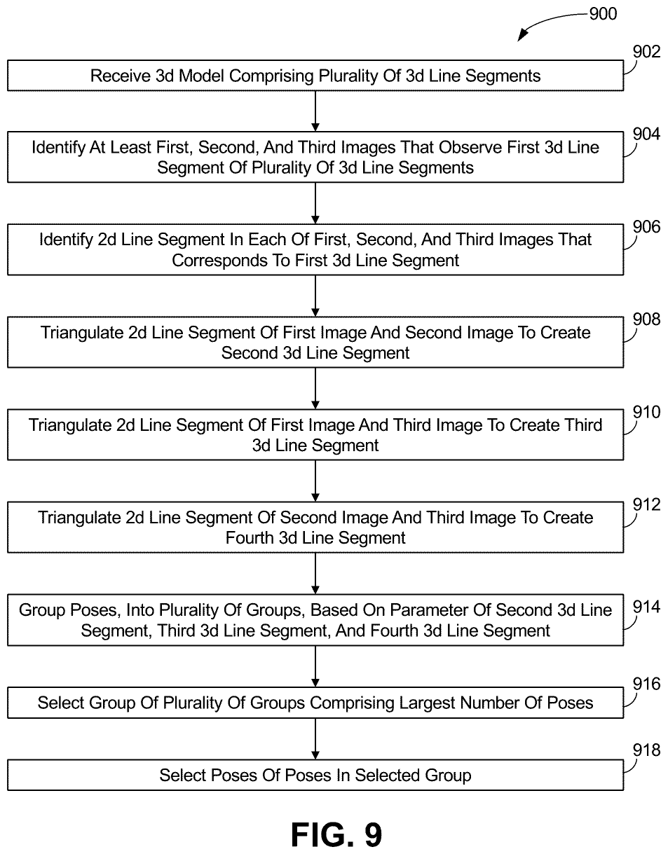

FIG. 9 illustrates a method 900 for grouping different camera poses, in accordance with one or more implementations. The operations of method 900 presented below are intended to be illustrative. In some implementations, method 900 may be accomplished with one or more additional operations not described, and/or without one or more of the operations discussed. Additionally, the order in which the operations of method 900 are illustrated in FIG. 9 and described below is not intended to be limiting.

In some implementations, method 900 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 900 in response to instructions stored electronically on an electronic storage medium. The one or more processing devices may include one or more devices configured through hardware, firmware, and/or software to be specifically designed for execution of one or more of the operations of method 900.

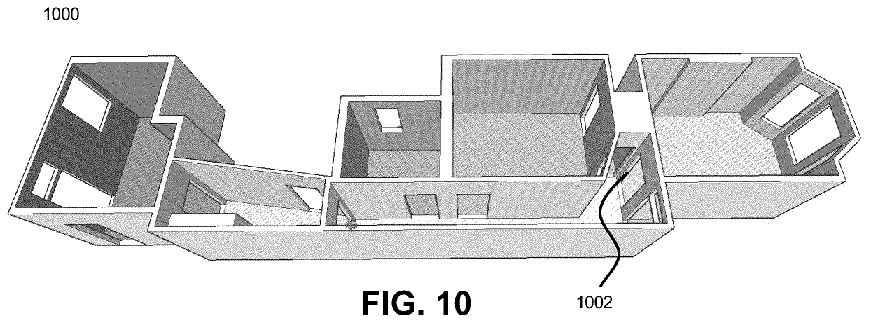

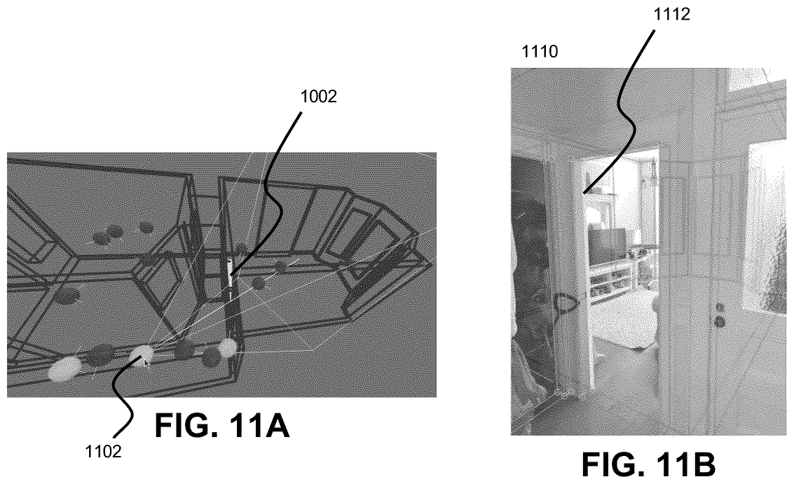

An operation 902 may include receiving a 3d model including a plurality of 3d line segments. The 3d model may be a polygon-based model, a primitive-based model, a line cloud, or a mesh model. Operation 902 may be performed by one or more hardware processors configured by machine-readable instructions including a module that is the same as or similar to model receiving module 808, in accordance with one or more implementations. Referring briefly to FIG. 10, it illustrates an exemplary 3d model, according to some embodiments. 3d model 1000 includes a plurality of line segments. The 3d model 1000 is a model of an interior of a building structure. Referring briefly to FIGS. 11A, 12A, and 13A, they illustrate exemplary views of an exemplary 3d model, according to some embodiments. For example, FIGS. 11A, 12A, 13A illustrates a view of the right-hand portion of the 3d model 1000 of FIG. 10.

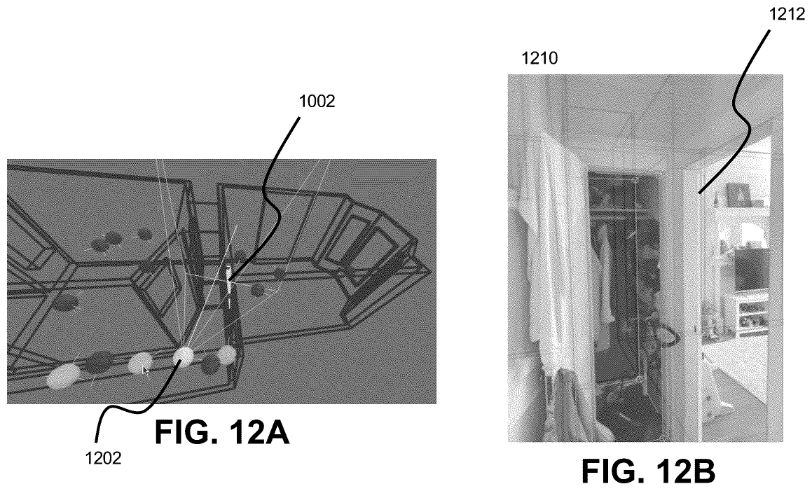

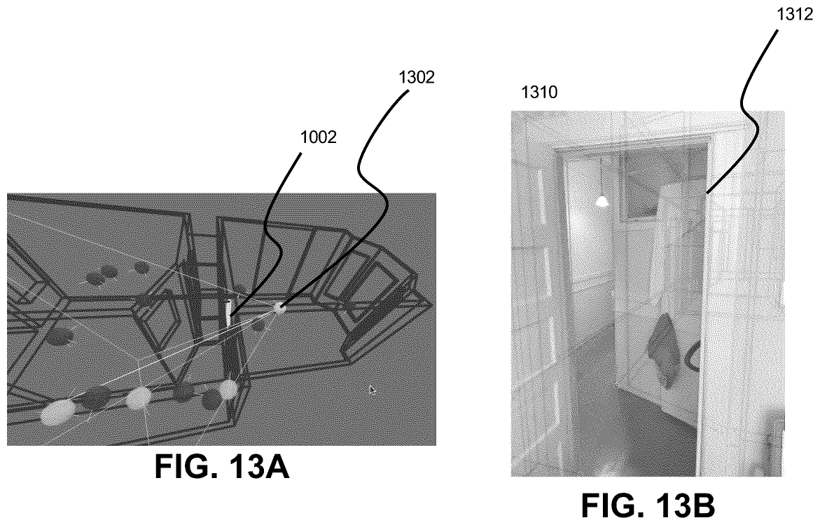

The method 900 may further include generating the 3d model based on at least first, second, and third images introduced in operation 904. Referring briefly to FIGS. 11B, 12B, and 13B, they illustrate exemplary images, according to some embodiments. FIG. 11B illustrates a first image 1110, FIG. 12B illustrates a second image 1210, and FIG. 13B illustrates a third image 1310. In some embodiments, the 3d model 1000 of FIG. 10 may be generated based on at least images 1110, 1210, and 1310. Generating the 3d model may include adjusting at least one of the poses associated with the first, second, or third images introduced in operation 904. In some embodiments, the poses associated with the first, second, or third images may be of cameras that captured first, second, or third images. Referring briefly to FIGS. 11A-11B, 12A-12B, and 13A-13B, a first camera with a first pose 1102 captured the first image 1110, a second camera with a second pose 1202 captured the second image 1210, and a third camera with a third pose 1302 captured the third image 1310. Adjusting the at least one of the poses may be in a 3d coordinate system. Adjusting the at least one of the poses include modifying at least one of position, orientation, angle, focal length, focal point, or distortion factor. In some embodiments, the poses associated with the first, second, or third images may be capture camera poses (i.e., poses of a device at time of capture of images), and the adjusted poses may be modified camera poses (i.e., poses used to generate the 3d model based on captured images). The capture camera poses may be poses produced by augmented reality frameworks. In some embodiments, the 3d model is not generated based on the first, second, and third images. In some embodiments, the 3d model 1000 of FIG. 10 may be generated based on at least images 1110, 1210, and 1310.

An operation 904 may include identifying at least first, second, and third images that observe a first 3d line segment of the plurality of 3d line segments in the model. That is, images that comprise a view of the observed first 3d line segment of the model are identified. Referring briefly to FIG. 10, first 3d line segment 1002 is a line segment of a plurality of 3d line segments in the 3d model 1000. Referring briefly to FIGS. 11A-11B, 12A-12B, and 13A-13B, the first image 1110, the second image 1210, and the third image 1310 observe the first 3d line segment 1002. Each of the first, second, and third images may be associated with a pose, and a pose may include orientation and position. For example, the first image may be associated with a first pose including a first camera orientation and a first camera position, the second image may be associated with a second pose including a second camera orientation and a second camera position, and the third image may be associated with a third camera pose including a third camera orientation and a third camera position. Referring briefly to FIGS. 11A-11B, 12A-12B, and 13A-13B, the first image 1110 may be associated with the first pose 1102, the second image 1210 may be associated with the second pose 1202, and the third image 1310 may be associated with the third pose 1302. Operation 904 may be performed by one or more hardware processors configured by machine-readable instructions including a module that is the same as or similar to image identifying module 110, in accordance with one or more implementations.

An operation 906 may include identifying a 2d line segment in each of the first, second, and third images that corresponds to the first 3d line segment. Referring briefly to FIGS. 11A-11B, 12A-12B, and 13A-13B, a first 2d line segment 1112 of the first image 1110, a second 2d line segment 1212 of the second image 1210, and a third 2d line segment 1312 of the third image 1310 each correspond to the first 3d line segment 1002 of the 3d model 1000. In some embodiments, a 2d line segment in an image may correspond to a part or a portion of the first 3d line segment. Referring briefly to FIGS. 12B and 13B, the second 2d line segment 1212 and the third 2d line segment 1312 correspond to a part or a portion of the first 3d line segment 1002. In some embodiments, a first 2d line segment in the first image may include a first 2d end point and a second 2d end point, a second 2d line segment in the second image may include a third 2d end point and a fourth 2d end point, and a third 2d line segment in the third image may include a fifth 2d end point and a sixth 2d end point. Operation 906 may be performed by one or more hardware processors configured by machine-readable instructions including a module that is the same as or similar to line segment identifying module 812, in accordance with one or more implementations.

In some embodiments, the first 3d line segment and the 2d line segment of the first, second, and third images may be vertical line segments. In these embodiments, the first 3d line segment and the 2d line segment of the first, second, and third images may be orthogonal to a ground plane. In some embodiments, the first 3d line segment and the 2d line segment of the first, second, and third images may be horizontal line segments. In these embodiments, the first 3d line segment and the 2d line segment of the first, second, and third images are parallel to a ground plane.

An operation 908 may include triangulating the 2d line segment of the first image and the second image to create a second 3d line segment. In some embodiments, triangulating the 2d line segment of the first image and the second image may include raycasting points from the 2d line segment of the first image and the second image. For example, triangulating the first 2d line segment and the second 2d line segment includes raycasting the first 2d end point of the first 2d line segment and the third 2d end point of the second 2d line segment to generate a first 3d end point of the second 3d line segment, and raycasting the second 2d end point of the first 2d line segment and the fourth 2d end point of the second 2d line segment to generate a second 3d end point of the second 3d line segment. Operation 908 may be performed by one or more hardware processors configured by machine-readable instructions including a module that is the same as or similar to line segment triangulating module 814, in accordance with one or more implementations.

An operation 910 may include triangulating the 2d line segment of the first image and the third image to create a third 3d line segment. In some embodiments, triangulating the 2d line segment of the first image and the third image may include raycasting points from the 2d line segment of the first image and the third image. For example, triangulating the first 2d line segment and the third 2d line segment includes raycasting the first 2d end point of the first 2d line segment and the fifth 2d end point of the third 2d line segment to generate a third 3d end point of the third 3d line segment; and raycasting the second 2d end point of the first 2d line segment and the sixth 2d end point of the third 2d line segment to generate a fourth 3d end point of the third 3d line segment. Operation 910 may be performed by one or more hardware processors configured by machine-readable instructions including a module that is the same as or similar to line segment triangulating module 814, in accordance with one or more implementations.

An operation 912 may include triangulating the 2d line segment of the second image and the third image to create a fourth 3d line segment. In some embodiments, triangulating the 2d line segment of the second image and the third image may include raycasting points of the 2d line segment of the second image and the third image. For example, triangulating the second 2d line segment and the third 2d line segment includes raycasting the third end point of the second 2d line segment and the fifth 2d end point of the third 2d line segment to generate a fifth 3d end point of the fourth 3d line segment; and raycasting the fourth 2d end point of the second 2d line segment and the sixth 2d end point of the third 2d line segment to generate a sixth 3d end point of the fourth 3d line segment. Operation 912 may be performed by one or more hardware processors configured by machine-readable instructions including a module that is the same as or similar to line segment triangulating module 814, in accordance with one or more implementations.

Referring briefly to FIGS. 11B, 12B, and 13B, the first 2d line segment 1110 and the second 2d line segment 1210 are triangulated to create a second 3d line segment, the first 2d line segment 1110 and the third 2d line segment 1310 are triangulated to create a third 3d line segment, and the second 2d line segment 1210 and the third 2d line segment 1310 are triangulated to create a fourth 3d line segment.

An operation 914 may include grouping poses, pose pairs, cameras, camera pairs, images, image pairs, or a combination thereof, into a plurality of groups, based on a parameter, or one or more parameters, of the second 3d line segment, the third 3d line segment, and the fourth 3d line segment. The parameter may be length, 3d coordinate points, orientation, location, or a combination thereof. The length may be of a reprojected feature such as a line feature or segment and may be reprojected according to its end points or other points along its length. In some embodiments, for example when the parameter is orientation, line segments that reproject as vertical may be distinguished from line segments that are non-vertical. The points may be of 3d line segments, for example end points. A group of the plurality of groups may include poses, pose pairs, cameras, camera pairs, images, image pairs, or a combination thereof, which are consistent with one another. Operation 914 may be performed by one or more hardware processors configured by machine-readable instructions including a module that is the same as or similar to pair grouping module 816, in accordance with one or more implementations.

Grouping may include batching poses, or pose pairs, into respective bins. By grouping into bins, poses, or pose pairs, that produce data consistent with other poses, or pose pairs may be identified. Similarly, poses, or pose pairs, that produce data inconsistent with other poses may be identified as outliers, and set into a separate grouping or bin as other poses, or pose pairs. In some embodiments, “consistent” data may mean reprojection of features according to a pose of one camera is consistent with reprojection of features according to a pose of another camera. In some embodiments, “consistent” data may be reprojection of features according to poses of a camera pair is consistent with reprojection of features according to poses of another camera pair. For example, if a reprojected feature, such as a point or a line, according to poses of a camera pair is consistent with how that same feature is reprojected according to poses of a different camera pair, then the two camera pairs may be said to be consistent. Further description of “consistent” is described below.

To identify consistency between poses, or pose pairs, parameters of the poses, or the pose pairs, may be grouped into one or more bins. When poses, or pose pairs, are associated with a particular bin, the quantity within any one bin indicates the consistency of the poses, or the pose pairs, of cameras within the bin or inconsistency with poses, or pose pairs, of cameras placed in other bins. For example, if five camera pairs, or pose pairs, were prepared for grouping, and three pairs fell within one bin with the other pairs falling within other bins, the bin with the three pairs may be the most consistent camera poses, or pose pairs, of the original five pairs subject to the grouping.

Bin size may be predetermined, or responsive. Bin size may be set by a parameter of a reprojected feature; for example a first bin may be an expected value of a reprojected feature, or range encompassing the expected value. The next group of bins may be sized for a standard deviation from the expected value range given the number of camera poses, or adjustable. For example, bin sizes covering too large of a range may group all inputs within a common bin and thus preclude identifying any inconsistencies between inputs. Similarly, bin size too fine may result in only single inputs allotted to any given bin and likewise preclude determining consistency between inputs. In some embodiments, bin size and quantity for grouping is adjustable to produce a majority or plurality of inputs to a single bin among a plurality of bins.

When grouped, and consistent cameras, or poses or pose pairs, identified, additional operations may be enabled or improved. Using consistent cameras, or poses or pose pairs, or discarding inconsistent cameras, or poses or pose pairs, may generate a new pose solution from which a new 3d model may be generated that is free of data from an inconsistent pose. Scaling information, such as from consistent cameras' positional services like an augmented reality framework, may be imputed into the 3d model (whether the original 3d model or a reconstructed 3d model).

A bin size of each group of the plurality of groups may be based on one or more expected values of the first 3d line segment. The one or more expected values may be based on the first 3d line segment. The one or more expected values may be based on a semantic class associated with the first 3d line segment. Each expected value of the one or more expected values may be based on an industry standard value. The bin size may be a percentage of the one or more expected values. The percentage may be an error threshold, for example three percent. For example, if the first 3d line segment is a vertical line segment that is associated with a “wall” semantic class, expected values may be between 96 inches and 120 inches, which are industry standard values of heights of walls in residential complexes, and a bin size may be three percent error threshold of 108 inches, the midpoint of 96 inches and 120 inches, or about three inches. In this example, “bin 96” may include values ±1.5 inches of 96 inches, “bin 99” may include values ±1.5 inches of 99 inches, and so on. In this example, “bin 96” has a bin range of 94.5 inches to 97.5 inches, and a midpoint of the bin range is 96 inches.

Referring briefly to FIGS. 11A-11B, 12A-12B, and 13A-13B, a first pose pair includes the first pose 1102 and the second pose 1202, a second pose pair includes the first pose 1102 and the third pose 1302, and a third pose pair includes the second pose 1202 and the third pose 1302. The first 3d line segment 1002 is associated with a “door” semantic class, and expected value may be between 80 inches and 96 inches, which are industry standard values of heights of doors in residential complexes, and a bin size may be three percent error threshold of 88 inches, the midpoint between 80 inches and 96 inches, or about 2.5 inches. The first pose pair and the third pose pair are batched into “bin 80” which includes values ±1.25 inches of 80 inches, and the second pose pair is batched into “bin 77.5” which includes values ±1.25 inches of 77.5 inches.

In some embodiments, the error threshold is based on sensor quality. In some embodiments, different devices that capture images may have different sensor qualities. In some examples, newer devices may have higher sensor quality than older devices. In some examples, more expensive devices may have higher sensor quality than less expensive devices. Sensors with high sensor quality may have favorable signal to noise ratios, favorable variation across time, temperature, and successive use, favorable drift during a capture session, and the like. In these examples, devices with higher sensor quality may have a lower error threshold than devices with lower sensor quality. In some embodiments, sensor quality may degrade over time, for example due to accumulated drift. In these embodiments, error thresholds may be a function of time, for example they may be lower at a beginning of a capture session of images than at an end of the capture session. A capture device that captured the images (e.g., the first, second, and third images), may undergo a calibration process before capturing the images. Poses associated with images captured after undergoing calibration process may be referred to as calibrated poses. A capture device that captured the images (e.g., the first, second, and third images), may not undergo a calibration process before capturing the images. Poses associated with images captured without undergoing a calibration process may be referred to as uncalibrated poses. In these embodiments, calibrated poses may have a higher sensor quality than uncalibrated poses. In these embodiments, calibrated poses may have a lower error threshold than uncalibrated poses. In some embodiments, the error threshold may be inversely related to a distance between poses. In these embodiments, the error threshold may be low for poses that are far apart and high for poses that are close together. In some embodiments, the error threshold may be inversely related to distances between a pose and planar surfaces in an image associated with a pose.

An operation 916 may include selecting a group of the plurality of groups including a largest number of poses, pose pairs, cameras, camera pairs, images, image pairs, or a combination thereof. Referring briefly to FIGS. 11A-11B, 12A-12B, and 13A-13B, “bin 80,” includes two pose pairs (the first pose pair and the third pose pair), and “bin 77.5” includes one pose pair (the second pose pair), and therefore “bin 80” is selected. Operation 916 may be performed by one or more hardware processors configured by machine-readable instructions including a module that is the same as or similar to group selection module 818, in accordance with one or more implementations.

An operation 918 may include selecting one or more poses, pose pairs, cameras, camera pairs, images, image pairs, or a combination thereof, of the poses, pose pairs, cameras, camera pairs, images, image pairs, or a combination thereof, in the selected group. In some embodiments, most common or most recurring pose, pose pair, camera, camera pair, image, or image pair, or combination thereof, is selected. Referring briefly to FIGS. 11A-11B, 12A-12B, and 13A-13B, “bin 80” includes the first pose pair (the first pose 1102 and the second pose 1202) and the third pose pair (the second pose 1202 and the third pose 1302). Of the first pose 1102, the second pose 1202, and the third pose 1302, the second pose 1202 is selected as it is common to both the first pose pair and the second pose pair. Operation 918 may be performed by one or more hardware processors configured by machine-readable instructions including a module that is the same as or similar to pose selection module 820, in accordance with one or more implementations.

In some embodiments, method 900 may further include calculating a scaling factor derived from the selected poses, pose pairs, cameras, camera pairs, images, image pairs, or a combination thereof, and the first 3d line segment, for example a length of the first 3d line segment. In some embodiments, the scaling factor may be derived from 2d line segments associated with the selected poses, pose pairs, cameras, camera pairs, images, image pairs, or a combination thereof, for example a lengths of the 2d line segments. In some embodiments, the scaling factor may be derived from 3d line segments associated with the selected poses, pose pairs, cameras, camera pairs, images, image pairs, or a combination thereof, for example a lengths of the 2d line segments. In some embodiments, the scaling factor may be derived from scene data as produced by augmented reality frameworks of cameras associated with the selected poses, pose pairs, cameras, camera pairs, images, image pairs, or a combination thereof, for example a lengths of the 2d line segments. In some embodiments, calculating the scaling factor includes calculating a mean of lengths of 3d line segments associated with the selected group. In some embodiments, calculating the scaling factor includes calculating a median of lengths of 3d line segments associated with the selected group. In some embodiments, calculating the scaling factor comprises calculating a midpoint of a bin range of the selected group. In some embodiments, calculating the scaling factor may include leveraging scene data as produced by augmented reality frameworks of the cameras in the selected group or associated with the selected poses, pose pairs, cameras, camera pairs, images, image pairs, or a combination thereof. Referring briefly to FIGS. 10, 11A-11B, 12A-12B, and 13A-13B, if a length of the first 3d line segment 1002 is 60 inches, and scene data as produced by augmented reality frameworks of cameras associated with the second pose 1202 and the second 2d line segments 1212, indicate a length of an associated 3d line segment is 80 inches, a scaling factor of 1.33 may be derived, where 1.33 is the value that 60 inches should be multiplied by to result in 80 inches.

In some embodiments, method 900 may further include updating the 3d model based on the scaling factor. Updating may include scaling the 3d model based on the scaling factor. Scaling the 3d model may include uniformly scaling the 3d model based on the scaling factor. For example, if the 3d model is L×L×L, uniformly scaling the 3d model may result in a scaled 3d model that is M×M×M. Scaling the 3d model may include non-uniformly scaling the 3d model based on the scaling factor. For example, if the 3d model is L×L×L, non-uniformly scaling the 3d model may result in a scaled 3d model that is M×M×L.

In some embodiments, the method 900 may further include generating a new 3d representation based on the selected poses, pose pairs, cameras, camera pairs, image, image pairs, or a combination thereof. The new 3d representation may be a mesh or a second 3d model. In some embodiments, the method 900 may further include generating a new pose solution based on the selected poses, pose pairs, cameras, camera pairs, image, image pairs, or a combination thereof. The new pose solution may be further based on images associated with the selected poses, pose pairs, cameras, camera pairs, image, image pairs, or a combination thereof. In some embodiments, the method 900 may further include updating the 3d model based on the selected poses, pose pairs, cameras, camera pairs, image, image pairs, or a combination thereof.

In some embodiments, the method 900, for example operation 904, may include identifying additional images that observe the first 3d line segment of the plurality of 3d line segments. In these embodiments, the method 900, for example operations 906-918, may be modified to consider the additional images.

In some embodiments, the first 3d line segment may be associated with one or more parameters. The parameter may be length, orientation, semantic class, or a combination thereof. In some embodiments, method 900 may further include identifying images that observe one or more additional 3d line segments with the same or similar parameters as the first 3d line segment (e.g., operation 904), identifying a 2d line segment in each of the images that correspond to the one or more additional 3d line segments (e.g., operation 906), triangulating the 2d line segment of pairs of images to create 3d line segments (e.g., operations 908, 910, and 912), grouping poses, pose pairs, cameras, camera pairs, images, image pairs, or a combination thereof into a plurality of groups based on a parameter, or one or more parameters of the created 3d line segments (e.g., operation 914), selecting a group of the plurality of groups including a largest number of poses, pose pairs, cameras, camera pairs, images, image pairs, or a combination thereof (e.g., operation 916), and selecting poses, pose pairs, cameras, camera pairs, images, image pairs, or a combination thereof, of the poses, pose pairs, cameras camera pairs, images, image pairs, or a combination thereof, in the selected group (e.g., operation 918). For example, if the first 3d line segment is a vertical line segment that is associated with a “door” semantic class, images that observe one or more additional 3d line segments that are vertical and associated with the “door” semantic class may be identified, a 2d line segment in each of the images that correspond to the one or more additional 3d line segments may be identified, the 2d line segment of pairs of images may be triangulated to create 3d line segments, poses, pose pairs, cameras, camera pairs, images, image pairs, or a combination thereof may be grouped into a plurality of groups based on a parameter, or one or more parameters, of the created 3d line segments, a group of the plurality of groups including a largest number of poses, pose pairs, cameras, camera pairs, images, image pairs, or a combination thereof, may be selected, and poses, pose pairs, cameras, camera pairs, images, image pairs, or a combination thereof, of the poses, pose pairs, cameras camera pairs, images, image pairs, or a combination thereof, in the selected group may be selected. In these embodiments, the method 900 may include additional images that observe additional 3d line segments which may result in additional poses, pose pairs, cameras, camera pairs, images, image pairs, or a combination thereof, for grouping and selection.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method of grouping different camera poses, the method comprising:
receiving a 3d model comprising a plurality of 3d line segments;
identifying at least first, second, and third images that observe a first 3d line segment of the plurality of 3d line segments, wherein each of the first, second, and third images is associated with a pose;
identifying a 2d line segment in each of the first, second, and third images that corresponds to the first 3d line segment;
triangulating the 2d line segment of the first image and the second image to create a second 3d line segment;
triangulating the 2d line segment of the first image and the third image to create a third 3d line segment;
triangulating the 2d line segment of the second image and the third image to create a fourth 3d line segment;
grouping pose pairs, into a plurality of groups, based on a parameter of the second 3d line segment, the third 3d line segment, and the fourth 3d line segment;
selecting a group of the plurality of groups comprising a largest number of pose pairs; and
selecting poses of the pose pairs in the selected group.

2. The method of claim 1, further comprising generating the 3d model based on at least the first, second, and third images, wherein generating the 3d model comprises adjusting at least one of the poses associated with the first, second, or third images.

3. The method of claim 1, wherein the parameter is length.

4. The method of claim 1, wherein a bin size of each group of the plurality of groups is based on one or more expected values of the first 3d line segment.

5. The method of claim 4, wherein the one or more expected values are based on the first 3d line segment.

6. The method of claim 4, wherein the one or more expected values are based on a semantic class associated with the first 3d line segment.

7. The method of claim 4, wherein each expected value of the one or more expected values is based on an industry standard value.

8. The method of claim 4, wherein the bin size is a percentage of the one or more expected values.

9. The method of claim 8, wherein the percentage corresponds to an error threshold.

10. The method of claim 1, further comprising:
calculating a scaling factor derived from on the selected poses and the first 3d line segment; and
updating the 3d model based on the scaling factor, wherein updating comprises scaling the 3d model based on the scaling factor.

11. The method of claim 1, further comprising generating a new 3d representation based on the selected poses.

12. The method of claim 1, further comprising generating a new pose solution based on the selected poses.

13. A non-transient computer-readable storage medium having instructions embodied thereon, the instructions being executable by one or more processors to perform a method for grouping different camera poses, the method comprising:
receiving a 3d model comprising a plurality of 3d line segments;
identifying at least first, second, and third images that observe a first 3d line segment of the plurality of 3d line segments, wherein each of the first, second, and third images is associated with a pose;
identifying a 2d line segment in each of the first, second, and third images that corresponds to the first 3d line segment;
triangulating the 2d line segment of the first image and the second image to create a second 3d line segment;
triangulating the 2d line segment of the first image and the third image to create a third 3d line segment;
triangulating the 2d line segment of the second image and the third image to create a fourth 3d line segment;
grouping pose pairs, into a plurality of groups, based on a parameter of the second 3d line segment, the third 3d line segment, and the fourth 3d line segment;
selecting a group of the plurality of groups comprising a largest number of pose pairs; and
selecting poses of the pose pairs in the selected group.

14. The computer-readable storage medium of claim 13, wherein the method further comprises generating the 3d model based on at least the first, second, and third images, wherein generating the 3d model comprises adjusting at least one of the poses associated with the first, second, or third images.

15. The computer-readable storage medium of claim 13, wherein the parameter is length.

16. The computer-readable storage medium of claim 13, wherein a bin size of each group of the plurality of groups is based on one or more expected values of the first 3d line segment.

17. The computer-readable storage medium of claim 16, wherein the one or more expected values are based on the first 3d line segment.

18. The computer-readable storage medium of claim 16, wherein the one or more expected values are based on a semantic class associated with the first 3d line segment.

19. The computer-readable storage medium of claim 16, wherein each expected value of the one or more expected values is based on an industry standard value.

20. The computer-readable storage medium of claim 16, wherein the bin size is a percentage of the one or more expected values.

21. The computer-readable storage medium of claim 20, wherein the percentage corresponds to an error threshold.

22. The computer-readable storage medium of claim 13, wherein the method further comprises:
calculating a scaling factor derived from on the selected poses and the first 3d line segment; and
updating the 3d model based on the scaling factor, wherein updating comprises scaling the 3d model based on the scaling factor.

23. The computer-readable storage medium of claim 13, wherein the method further comprises generating a new 3d representation based on the selected poses.

24. The computer-readable storage medium of claim 13, wherein the method further comprises generating a new pose solution based on the selected poses.
